(19) United States
(12) Patent Application Publication
(10) Pub. No.: US 2003/0014232 A1
(43) Pub. Date: Jan. 16, 2003

(54) Methods for predicting biological activities of cellular constituents

(76) Inventors: Thomas S. Paterson, West Hollywood, CA (US); Renee A. Fallon, Palo Alto, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/153,847

(22) Filed: May 21, 2002

Related U.S. Application Data
(60) Provisional application No. 60/292,848, filed on May 22, 2001.

(51) Int. Cl. G06G 7/48

(52) U.S. Cl. 703/11

(57) ABSTRACT

Methods for predicting the activity of cellular constituents in a biological system are described. In particular, a method for predicting the potential biological activity of a cellular constituent for affecting a biological state is described. A method for identifying biological processes of a biological state modulated by a cellular constituent is also described. Also included is a method for predicting biological processes involved in the action of a drug.

### TECHNICAL FIELD

The field of this invention relates to methods for predicting the activity of cellular constituents in a biological system. In particular, it relates to methods for identifying cellular constituents that modify the responses of biological systems to varying stimuli, and applications of these methods to drug discovery.

### BACKGROUND

In the post-genomic era, pharmaceutical companies are inundated with information on large numbers of novel genes with no systematic way of prioritizing one gene over another for further investigations.

In a typical scenario, a pharmaceutical company becomes aware of a newly sequenced gene of unknown function. This gene shares sequence homology with known genes whose protein functions are, to some extent, understood. By implication, the protein of the newly sequenced gene may be in the same class as the known genes, and therefore some similar functionality may be inferred. The pharmaceutical company becomes particularly interested in this gene as there is circumstantial evidence associating this gene with a particular disease. This evidence may come in several forms: samples from diseased tissue demonstrating a significantly higher (or lower) level of expression of the novel gene relative to samples from normal tissue, individuals with the disease may show a SNP or higher (haplotype) polymorphism in the gene relative to healthy individuals. The company then perceives that the gene, or more specifically the protein(s) for which the gene codes as a potential drug target or as a “disease gene” with diagnostic applications for disease predisposition or drug response. In addition to this gene, the company has knowledge of many other genes that may be associated with the same disease.

As drug development entails extremely time consuming and expensive laboratory experiments, animal experiments, and clinical trials, the company has to select a few genes on which to spend their resources. However, the pharmaceutical companies do not have a systematic method of prioritizing one gene over another for further investigations. Therefore, there is a great demand in the art for methods to predict the role of particular cellular components in biological systems.

Relevant Literature

Brown, Disease simulation system and method, U.S. Pat. No. 5,956,501 (1999).

Brown, Disease simulation system and method, U.S. Pat. No. 6,233,539 B1 (2001).

Fink, et al., Hierarchical biological modelling system and method, U.S. Pat. No. 5,657,255 (1997).

Fink, et al., Hierarchical biological modelling system and method, U.S. Pat. No. 5,808,918 (1998).

Friend, et al., Methods for using co-regulated genesets to enhance detection and classification of gene expression patterns, U.S. Pat. No. 6,203,987 B1 (2001).

Friend, et al., Method for determining the presence of a number of primary targets of a drug, U.S. Pat. No. 6,146,830 (2000).

Herren, et al., Integrated disease information system, U.S. Pat. No. 6,108,635 (2000).

Iris, et al., Method for identifying genes underlying defined phenotypes, U.S. Pat. No. 6,221,585 (2001).

Kephart, et al., Method and system for identification of genetic information from a polynucleotide sequence, U.S. Pat. No. 6,094,626 (2000).

McAdams, et al., System and method for simulating operation of biochemical systems, U.S. Pat. No. 5,914,891 (1999).

Paterson, et al., Method of managing objects and parameter values associated with the objects within a simulation model, U.S. Pat. No. 6,078,739 (2000).

Paterson, et al., Method of providing access to object parameters within a simulation model, U.S. Pat. No. 6,069,629 (2000).

Paterson, et al., Method of generating a display for a dynamic simulation model utilizing node and link representations, U.S. Pat. No. 6,051,029 (2000).

Paterson, et al., Method and apparatus for conducting linked simulation operations utilizing a computer-based system model, U.S. patent application filed Mar. 21, 2001.

Paterson, et al., A method of monitoring values within a simulation model, PCT Publication No. WO 99/27443 (1999).

Paterson, et al., Method and apparatus for conducting linked simulation operations utilizing a computer-based system model, PCT Publication No. WO 00/63793 (2000).

Paterson, Analyzing and validating a computer-based model, U. S. patent application filed May 17, 2001.

Renner, et al., Expression cloning processes for the discovery characterization, and isolation of genes encoding polypeptides with a predetermined property, U.S. Pat. No. 6,197,502 (2001).

Stoughton, et al., Methods for identifying pathways of drug action, U.S. Pat. No. 5,965,352 (1999).

Thalhammer-Reyero, Computer-based system and methods for information storage, modeling and simulation of complex systems organized in discrete compartments in time and space, U.S. Pat. No. 5,930,154 (1999).

Thalhammer-Reyero, Computer-based system, methods and graphical interface for information storage, modeling and simulation of complex systems, U.S. Pat. No. 5,980,096 (1 999).

Winslow, et al., Computational system and method for modeling the heart, U.S. Pat. No. 5,947,899 (1999).

Winslow, et al., System and method for modeling genetic, biochemical, biophysical and anatomical information, PCT Publication No. WO00/65523 (2000).

### SUMMARY OF THE INVENTION

One aspect of the invention is a method for predicting potential biological activity of a cellular constituent for affecting a biological state S comprising: (a) assigning a set F₀ of functions to said cellular constituent, each function of set F₀ being a modification of at least one biological process of said biological state S; (b) adding information for one function of set F₀ to a computer model of said biological state, said computer model representing a plurality of individual biological processes associated with said biological state, at least one of said plurality of individual biological processes being a process modified by said one function of set F₀, said computer model being configured to evaluate the effect of said biological processes on said biological state; (c) executing said computer model with said added one function of set F₀ to produce value Sₓ for said biological state in the presence of said added one function of set F₀; (d) repeating steps (b) and (c) for any other functions of set F₀; (e) comparing all of said Sₓ values for functions of set F₀ to an S₀ value, said S₀ value being produced by executing said computer model without any of the functions of set F₀ being incorporated into said computer model; and (f) identifying the functions in set F₀ having a difference in Sₓ value relative to S₀ as having a higher potential biological activity of said cellular constituent for affecting said biological state and identifying the functions in set F₀ having substantially no difference in Sₓ value relative to S₀ as having a lesser potential biological activity for affecting said biological state.

Another aspect of the invention is a method for selecting a subset Z₁ of cellular constituents having a potential biological activity for affecting biological state S from a set Z₀ of cellular constituents, comprising: (a) assigning a set F₀ of functions to each cellular constituent of set Z₀, each function being a modification of at least one biological process of said biological state S; (b) adding information for one of said functions of set F₀ for one of said cellular constituents of set Z₀ to a computer model of said biological state, said computer model representing a plurality of individual biological processes associated with said biological state, at least one of said plurality of individual biological processes being a process modified by said one function of set F₀, said computer model being configured to evaluate the effect of said individual biological processes on said biological state; (c) executing said computer model with said added one function of set F₀ of said one cellular constituent being incorporated into the computer model to produce a value S_{X} for said biological state in the presence of said one function of set F₀of said one cellular constituent; (d) repeating steps (b) and (c) for any other functions of set F₀; (e) repeating steps (b), (c) and (d) for any other cellular constituents of set Z₀; (f) comparing all of said S_{X} values for cellular constituents in set Z₀ to a S₀ value, said S₀ value being produced by executing said computer model without any of said functions of any of said cellular constituents being incorporated into the computer model; (g) establishing a selection characteristic for potential members of said subset Z₁, said selection characteristic being a range of differences between Sₓ values for cellular constituents in set Z₀ to S₀; and (h) assigning to said subset Z₁ cellular constituents having said selection characteristic, the difference in Sₓ values to S₀ value being correlated to the potential biological activity of said cellular constituent for affecting said biological state.

Yet another aspect of the invention is a method for identifying potential biological processes of a biological state modulated by a cellular constituent comprising: (a) assigning a function to said cellular constituent, said function being a modification of at least one biological process of said biological state; (b) adding information for said function to a computer model of said biological state, said computer model representing a plurality of individual biological processes associated with said biological state, at least one of said plurality of individual biological processes being a process modified by said function, said computer model being configured to evaluate the effect of said biological processes on said biological state; (c) executing said computer model so that a virtual stimulus in the presence of said function is presented to produce a response value Rₓ for said biological state in the presence of said function; (d) providing a biological stimulus to a biological assay system to produce a biological response value BRₓ for said biological assay system in the presence of said biological stimulus, said biological stimulus being the biological equivalent of the virtual stimulus and said biological assay system being the biological equivalent of the said biological state; (f) establishing a selection characteristic for identifying potential biological processes of said biological state modulated by said cellular constituent, wherein said selection characteristic being a range of differences between the response value Rₓ and the biological response value BRₓ; and (g) identifying said biological process having said selection characteristic as a potential biological process of said biological state modulated by said cellular constituent.

Another aspect of the invention is a method for predicting potential biological activity of a cellular constituent for affecting a biological state S, comprising: (a) assigning a set F₀ of functions to said cellular constituent, each function of set F₀ being a modification of at least one biological process of said biological state S; (b) adding information for one function of set F₀ to a computer model of said biological state, said computer model representing a plurality of individual biological processes associated with said biological state, at least one of said plurality of individual biological processes being a process modified by said one function of set F₀, said computer model being configured to evaluate the effect of said biological processes on said biological state; (c) executing said computer model with said added one function of set F₀ to produce value Sₓ for said biological state in the presence of said added one function of set F₀; (d) repeating steps (b) and (c) for any other functions of set F₀; (e) comparing all of said Sₓ values for functions of set F₀ to an S₀ value, said S₀ value being produced by executing said computer model without any of the functions of set F₀ being incorporated into said computer model; (f) establishing a selection characteristic for potential members of a subset F₁ of set F₀, said selection characteristic being a range of differences between Sₓ values for functions in set F₀ to S₀; and (g) assigning to said subset F₁ functions having said selection characteristic, the selection characteristic for potential members of subset F₁ being correlated to the potential biological activity of said cellular constituent for affecting said biological state. A further subset F₂ of functions of said cellular constituent from said subset F₁ of functions can be created, said creating a subset F₂ of functions of said cellular constituent from said subset F₁ of functions, said creating the subset F₂ of functions, comprising: (a) perturbing said cellular constituent in a biological assay system; (b) executing said biological assay system in the presence of said perturbed cellular constituent to produce a set of function values, each function value FVₓ of said set of function values being related to one function of subset F₁; (c) comparing each function value FVₓ to a function value FV₀, the function value FV₀ being a value produced without perturbation of said cellular constituent in said biological assay system; (d) establishing a selection characteristic for potential members of said subset F₂, said selection characteristic being a range of differences between FVₓ values and FV₀ values; and (e) assigning to said subset F₂ functions having said selection characteristic, the selection characteristic for potential members of subset F₂ being correlated to the potential biological activity of said cellular constituent for affecting said biological state.

Another aspect of the invention is a method for predicting potential biological activity of a cellular constituent for affecting a biological state S, the method using a computer model that represents a plurality of individual biological processes associated with said biological state, said computer model being configured to evaluate an effect of said individual biological processes on said biological state, the method comprising: (a) assigning a set F₀ of functions to said cellular constituent, each function of set F₀ being a modification of at least one biological process of said biological state S; (b) performing the following for each function from the set F₀: (i) adding information for one function of set F₀ to a version of the computer model without added information for the remaining functions of set F₀, at least one of said plurality of individual biological processes being a process modified by said added one function of set F₀; and (ii) executing said computer model with said added one function of set F₀ to produce value Sₓ for said biological state in the presence of said added one function of set F₀; (c) comparing all of said Sₓ values for functions of set F₀ to an S₀ value, said S₀ value being produced by executing said computer model without any of the functions of set F₀ being incorporated into said computer model; and (d) identifying the functions in set F₀ having a difference in its associated Sₓ value relative to S₀ as having a higher potential biological activity of said cellular constituent for affecting said biological state and identifying the functions in set F₀ having substantially no difference in Sₓ value relative to S₀ as having a lesser potential biological activity for affecting said biological state.

### BRIEF DESCRIPTION OF THE DRAWINGS

FIG. 1 shows a flowchart for predicting potential biological activity of a cellular constituent for affecting a biological state S, according to an embodiment of the invention.

FIG. 2 shows a flowchart for selecting a subset Z₁ of cellular constituents having a potential biological activity for affecting biological state S from a set Z₀ of cellular constituents, according to an embodiment of the invention.

FIG. 3 shows a flowchart for identifying potential biological processes of a biological state modulated by a cellular constituent, according to an embodiment of the invention.

FIG. 4 depicts the parameter set for an allergen challenge.

FIG. 5 depicts the experimental protocol for the allergen challenge.

FIG. 6 depicts FEV₁ and levels of lipid mediators in response to an antigen challenge.

FIG. 7 depicts the effect of blocking lipid mediators on FEV₁.

FIG. 8 depicts the responses for a 24 hour period from a computer model of an obese diabetic patient consuming 3 meals a day.

FIG. 9 is a schematic representation of a computer system within which software for performing the methods of the invention may reside or be executed.

FIG. 10 depicts the nodes and links used in a computer model used to implement the methods of the invention.

FIG. 11 shows a summary diagram of the functional and anatomical aspects of a computer model of obesity.

FIG. 12 depicts a process that is a part of the computer model of obesity.

FIG. 13 shows the various parameters and their values, that can be modified to evaluate the effects of blocking CysLT with an antagonist.

FIG. 14 depicts the experimental set-up of exposing an asthmatic patient to an allergen in the presence of a CysLT antagonist.

FIG. 15A and B depict a flowchart for predicting potential biological activity of a cellular constituent for affecting a biological state, according to an embodiment of the invention.

FIG. 16 depicts a flowchart of a method of the invention for identifying whether a novel gene can be used a drug target.

### DETAILED DESCRIPTION

The present invention relates to methods for identifying biological activities of cellular constituents. In particular, the methods of the invention enables one to determine the function of a cellular constituent in a particular biological state and also to prioritize the role of cellular constituents in particular biological states. Further, the invention also relates to identifying the biological processes modulated by drugs.

Biological State, Biological Processes, Cellular Constituents

A “biological state” is the result of the occurrence of a, series of biological processes. Each biological process of the biological state is influenced according to some biological mechanism by one or more other biological processes in the biological state. As the biological processes change relative to each other, the biological state also undergoes changes. One measurement of a state is the relationship of a collection of cellular constituents to each other or to a standard. Biological states, as referred to herein, are well known in the art. Biological states depend on various biological mechanisms by which the biological processes influence one another. A biological state can include the state of an individual cell, an organ, a tissue, and a multi-cellular organism. A biological state can also include the state of a nutrient or hormone concentration in the plasma, interstitial fluid, intracellular fluid, or cerebrospinal fluid; e.g. the states of hypoglycemia or hypoinsulinemia are low blood sugar or low blood insulin. These conditions can be imposed experimentally, or may be conditions present in a patient type. For example, a biological state of a neuron can include the state in which the neuron is at rest, the state in which the neuron is firing an action potential, and the state in which the neuron is releasing a neurotransmitter. In another example, the biological states of the collection of plasma nutrients can include the state in which the person awakens from an overnight fast, the state just after a meal, and the state between meals. A biological state can also include a “disease state,” which is taken to mean the result of the occurrence of a series of biological processes, wherein one or more of the biological processes of the state plays a role in the cause or the symptoms of the disease. A disease state can be of a diseased cell, a diseased organ, a diseased tissue, and a diseased multi-cellular organism. Exemplary diseases include diabetes, asthma, obesity, and rheumatoid arthritis. A diseased multi-cellular organism can be an individual human patient, a specific group of human patients, or the general human population as a whole. A diseased state could include a diseased protein (such as a defective glucose transporter) or a diseased process, such as defects in clearance, degradation or synthesis of a system constituent, which may occur in several different organs.

A “biological process” is generally understood to be the occurrence of interactions between cellular constituents. Each cellular constituent of the biological process is influenced according to some biological mechanism by one or more other cellular constituents in the process. Biological processes can also include chemical processes. Biological processes include processes that occur within or in contact with the environment of a cell, organ, tissue, or multi-cellular organism. The cellular constituents making up a particular process can be either extra-cellular or intra-cellular. For example, the cellular constituents of a process can include DNA, RNA, proteins, enzymes, hormones, cells, organs, tissues, portions of cells, tissues, or organs, subcellular organelles like mitochondria, nucleus, Golgi complex, lysosome, endoplasmic reticulum, and ribosome, chemically reactive molecules like H⁺, superoxides, ATP, citric acid, protein albumin, combinations of these types of cellular constituents. Each cellular constituent of the biological process is influenced by at least one other cellular constituent in the biological process by some biological mechanism, which need not be specified or even understood. A biological process, therefore, refers both to the collection of cellular constituents drawn from some aspect of the biological state together with the network of interactions between the constituents.

Concrete examples of biological processes, as understood herein, are well known in the art. They depend on various biological mechanisms by which the cellular constituents influence one another. Biological processes include well-known biochemical pathways in which, for example, molecules are broken down to provide cellular energy or built up to provide cellular energy stores, molecules are built up to provide cellular structure or energy stores, or in which proteins or nucleic acids are synthesized or activated, or in which protein or nucleic acid precursors are synthesized. The cellular constituents of synthetic pathways include enzymes and the synthetic intermediates, and the influence of a precursor molecule on a successor molecule is by direct enzyme-mediated conversion. Further, the cellular constituents of biochemical pathways include enzymes, substrate precursors, intermediate species, and the influence of the product molecule on a successor molecule is catalyzed by an enzyme-mediated conversion. Biological processes also include signaling and control pathways, many examples of which are also well known. Cellular constituents of these pathways include, typically, primary or intermediate signaling molecules, as well as the proteins participating in the signal or control cascades usually characterizing these pathways. In signaling pathways, binding of a signal molecule to a receptor usually directly influences the abundances of intermediate signaling molecules and indirectly influences the degree of phosphorylation (or other modification) of pathway proteins. Both of these effects in turn influence activities of cellular proteins that are key effectors of the cellular processes initiated by the signal, for example, by affecting the transcriptional state of the cell. Control pathways, such as those controlling the timing and occurrence of the cell cycle, are similar. Here, multiple, often ongoing, cellular events are temporally coordinated, often with feedback control, to achieve a consistent outcome, such as cell division with chromosome segregation. This coordination is a consequence of functioning of the pathway, often mediated by mutual influences of proteins on each other's degree of phosphorylation (or other modification). Also, well known control pathways seek to maintain optimal levels of cellular metabolites in the face of a fluctuating environment. Further examples of biological processes operating according to understood mechanisms will be known to those of skill in the art.

Biological processes can be hierarchical, non-hierarchical, or a combination of hierarchical and non-hierarchical. In more detail, a hierarchical process is one in which its cellular constituents can be arranged into a hierarchy of numbered levels so that cellular constituents belonging to a particular numbered level can be influenced by cellular constituents belonging to other levels. A hierarchical process generally originates from the lowest numbered cellular constituents. In contrast, a non-hierarchical process has one or more feedback loops. A feedback loop in a biological process is a subset of cellular constituents of the process, each constituent of the feedback loop influences and also is influenced by other constituents of the feedback loop.

In summary, therefore, as used herein, a biological process is an interaction or series of interactions between cellular constituents. The cellular constituents influence one another through any biological mechanism, known or unknown, such as by a cell's synthetic, regulatory, homeostatic, or control networks. The influence of one cellular constituent on another can be, inter alia, by a synthetic transformation of the one cellular constituent into the other, by a direct physical interaction of the two cellular constituents, by an indirect interaction of the two cellular constituents mediated through intermediate biological events, or by other mechanisms.

Drugs

According to the current invention, drugs are any compounds of any degree of complexity that perturb a biological state, whether by known or unknown mechanisms and whether or not they are used therapeutically. Drugs thus include: typical small molecules of research or therapeutic interest; naturally-occurring factors, such as endocrine, paracrine, or autocrine factors or factors interacting with cell receptors of all types; intracellular factors, such as elements of intracellular signaling pathways; factors isolated from other natural sources; pesticides; herbicides; and insecticides. The biological effect of a drug may be a consequence of, inter alia, drug-mediated changes in the rate of transcription or degradation of one or more species of RNA, the rate or extent of translation or post-translational processing of one or more polypeptides, the rate or extent of the degradation of one or more proteins, the inhibition or stimulation of the action or activity of one or more proteins, and so forth. In fact, most drugs exert their affects by interacting with a protein. Drugs that increase rates or stimulate activities or levels of a cellular constituent are called herein “activating drugs”, while drugs that decrease rates or inhibit activities or levels of cellular constituents are called herein “inhibiting drugs”. As will be clear to the skilled artisan, while the invention is described herein in terms of identifying the biological processes modulated by a “drug,” it is equally applicable to identifying the potential biological processes modulated by a particular composition which comprises or contains a drug, but which may vary in its targets from a different composition containing the same drug but different additional ingredients.

In addition to drugs, this invention is equally applicable to those changes in the aspects of the physical environment that perturb a biological state in targeted manners. Such environmental changes can include moderate changes of temperature (e.g., a temperature elevation of 10° C.) or exposure to moderate doses of radiation. Other environmental aspects include the nutritional environment, such as the presence of only particular sugars, amino acids, and so forth.

Computer Models of a Biological System

The methods disclosed herein can be suitably implemented with any of the computer models of biological states that are known in the art. Computer models of biological systems are described in the following references—Paterson et al., U.S. Pat. No. 6,078,739; Paterson et al., U.S. Pat. No. 6,051,029; Paterson et al., U.S. Pat. No. 6,069,629; Fink et al., U.S. Pat. No. 5,808,918; Fink et al., U.S. Pat. No. 5,657,255; Paterson et al., PCT application, WO 99/27443; Paterson et al. PCT application, WO 00/63793; Winslow et al., PCT publication WO 00/65523; McAdams et al., U.S. Pat. No. 5,914,891; Thalhammer-Reyero, and U.S. Pat. No. 5,930,154. Suitably this invention can be implemented with the following commercially available computer models of biological states—Entelos® Asthma PhysioLab® systems, Entelos® Obesity PhysioLabo® systems and Entelos® Adipocyte CytoLab™ systems. Other computer models of biological states, which can be used to implement this invention, will be apparent to a person of skill in the art.

Suitably, the computer model used to implement the invention comprises a method and apparatus that allows critical integrated evaluation of conflicting data and alternative hypotheses. The model represents processes at the lowest level, and the larger biological systems impacting on these processes, and thus provides a multi-variable view of the system. The model also provides cross-disciplinary observations through synthesis of information from two or more disciplines into a single model, or through linking two models which respectively represent different disciplines.

The computer model used to implement the invention can be hierarchical, and reflect the particular system and anatomical factors relevant to the issues to be explored by the model. The level of detail at which the hierarchy starts, and the level of detail at which the hierarchy ends, are largely dictated by the particular intended use of the model. Because the cellular constituents being evaluated often operate at the subcellular level, the lowest level of the hierarchy may be the subcellular level. The subcellular level includes cellular constituents like DNA, mRNA proteins, chemically reactive molecules, and subcellular organelles. And because the individual is the most common entity of interest with respect to the ultimate effect of the cellular constituent, the individual (often presented in the form of clinical observables) can be at the highest level of the hierarchy.

The computer models may represent biological states of patients, organisms, cells, tissues, or organs. The computer models can be executed with or without using virtual stimuli, thereby obtaining a value for the biological state represented by the computer model. This value is a set of measurements of levels or activities of cellular constituents or measurements of observable and/or measurable behavior of the biological state which are referred to as the phenotype of the biological state. When the value is obtained following the use of a virtual stimulus, the value can be referred to as a response value.

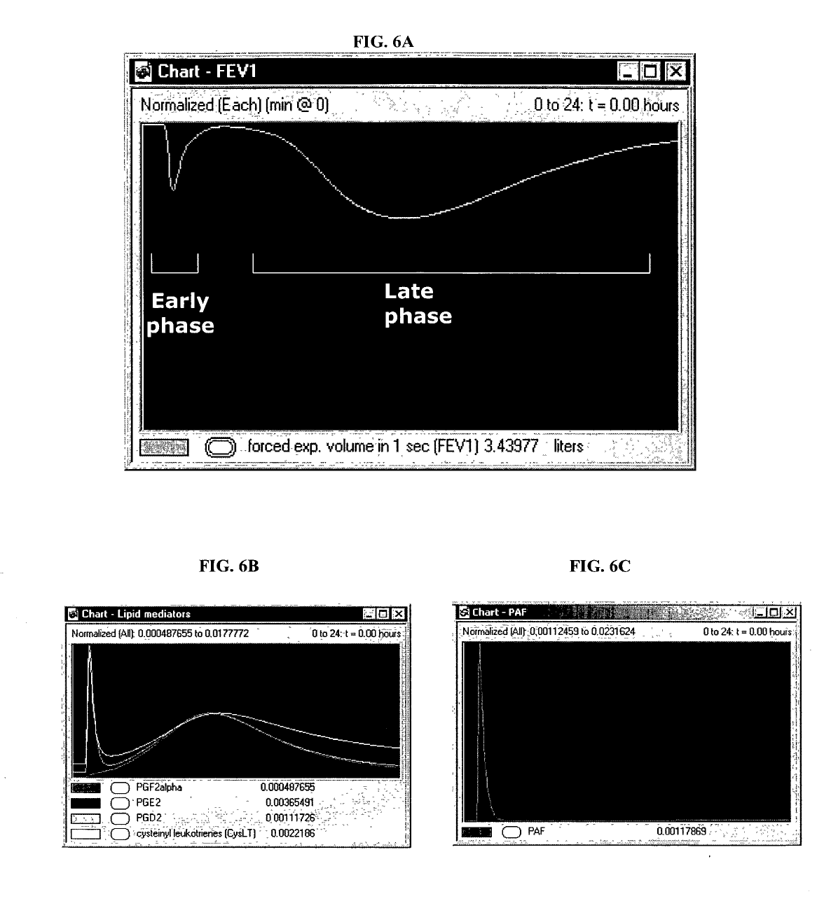

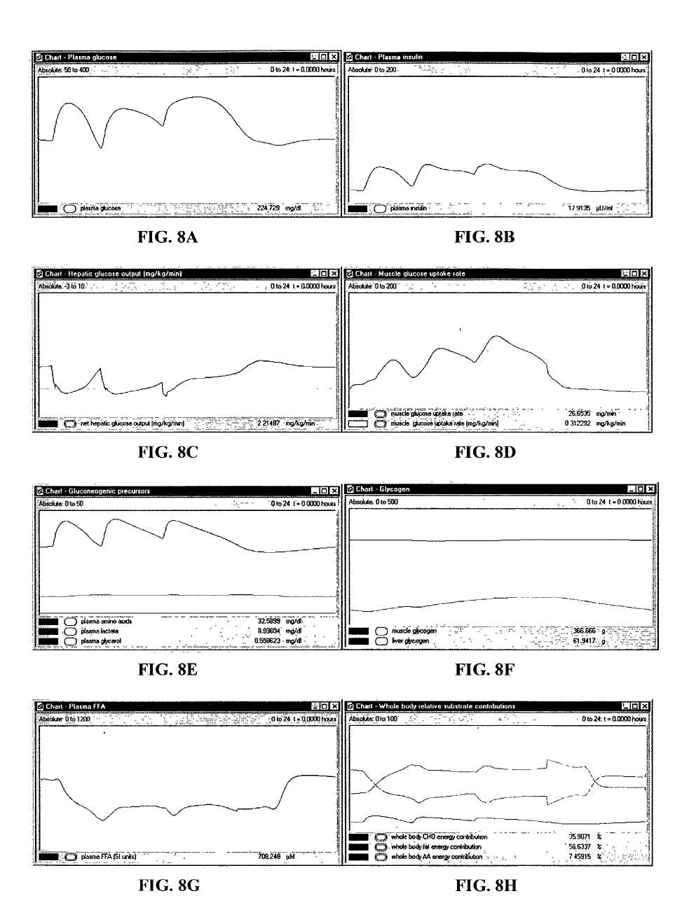

For example, a model of an obese diabetic patient consuming 3 meals a day (55% carbohydrates, 30% fat, 15% protein) can be executed and the following measurements for a 24 hour period can be obtained—circulating levels of glucose (FIG. 8A), insulin (FIG. 8B), free fatty acids (FFA) (FIG. 8G), gluconeogenic precursors (FIG. 8E): lactate, amino acids, and glycerol, as well as the dynamics of processes like hepatic glucose output (FIG. 8C), muscle glucose uptake (FIG. 8D), relative contributions of whole body carbohydrate, fat and amino acid oxidation (FIG. 8H), and the expansion and depletion of the muscle and liver glycogen storage pools are also shown (FIG. 8F). In addition, behavior that can be measured includes appetite and satiety over the 24 hour period. One or a combination of these measurements and/or behaviors can be the value of the biological state of an obese diabetic patient. In another example, the asthma computer model can be stimulated with an antigen challenge every five days. In response to this virtual stimulus of an antigen challenge, the following measurements can be obtained—airway conductance, eosinophil population in tissue, and levels of inflammatory mediators like histamine, bradykinin, cysteinyl leukotrienes, and prostaglandin D2. See FIGS. 6A and 6B. One or a combination of these measurements can be the value of the biological state of an asthma patient.

The computer model can represent the underlying genotype and environmental factors that give rise to the phenotype. It is possible that one phenotype is the result of more than one set of genotype and environmental factors. For example, two patients may appear to be similarly overweight, but one could be overweight because of genetic susceptibility, and the other could be overweight because of diet and lifestyle choices.

The computer models can represent patients such that these models can then be used to predict the clinical responses to therapeutic modulations of the biological processes. These models can be used to predict how different therapies affect the responses of medical patients either having the same phenotype but different underlying conditions or having different phenotypes. The different therapies can then be used on the computer models of different patients to predict responses to different therapies.

The biological state being represented in the computer model can represent a normal state, i.e., a state lacking any disease processes. The computer model can contain parameters for representing the disease state of the biological state being represented. By selecting one or more of these parameters, the user can modify the normal biological state to a diseased state.

The computer models used to implement this invention can behave similar to or behave as closely as possible to the biological state they represent. To implement the invention, the cellular constituent being evaluated does not have to be explicitly depicted in the biological processes of the computer model. An embodiment of the invention relates to the concept that the contribution of the cellular constituents to a particular biological state is implicitly present in the biological processes of the computer model. Suitably, the computer model accurately depicts the biological state being studied. The responses of the computer model, for example, can be validated against biological responses obtained in a biological assay system. For example, in an adipocyte cell culture, changes in levels of leptin can be measured in response to changes in levels of free fatty acids. In a computer model of adipocyte cells, when changes in levels of free fatty acids are accounted for in the computer model, suitably the response obtained is similar to that seen in the adipocyte cell culture. The computer model used to implement the invention, for example, can be validated with in vitro and in vivo data obtained using biological assay systems of the biological state being modeled. For example, the obesity model would be validated with data from adipocyte cell cultures, mice models of obesity, and/or obese patients. Methods for validation of computer models are described in co-pending application entitled “Developing, analyzing and validating a computer-based model,” filed on May 17, 2001.

Alternative computer models of biological systems for implementing this invention will be apparent to one of skill in the art, and are intended to be comprehended within the accompanying claims.

Overview of Methods of the Invention

The methods of the present invention enable a user to identify the biological activity of a cellular constituent. Also, the methods enable the identification of the biological processes modulated by a drug. In particular, the methods of the invention help the prioritization of cellular constituents or drugs for further scientific investigation.

The term “biological activity” as used herein means the natural or normal function in a biological or disease state. In some embodiments, the methods of the present invention are used to identify the potential biological activity of a cellular constituent. The term “potential biological activity” is used herein to mean a biological activity that has been identified as an activity that has some likelihood of being a function in a particular biological or disease state. That is, the potential biological activity has some possibility for being biologically relevant in the biological or disease state being evaluated. Examples of biological activities of a cellular constituent include binding to other cellular constituents and/or modulation of activity or structure of other cellular constituents. For example, the biological activities of insulin include binding to the insulin receptor, modulation of glucose levels, and modulation of free fatty acid levels.

As described below, the methods of the invention can comprise of one or more steps. If a method comprises of two or more steps, it is not necessary that the steps be performed in the exact order described. Also, it is not necessary that all the steps be performed concurrently.

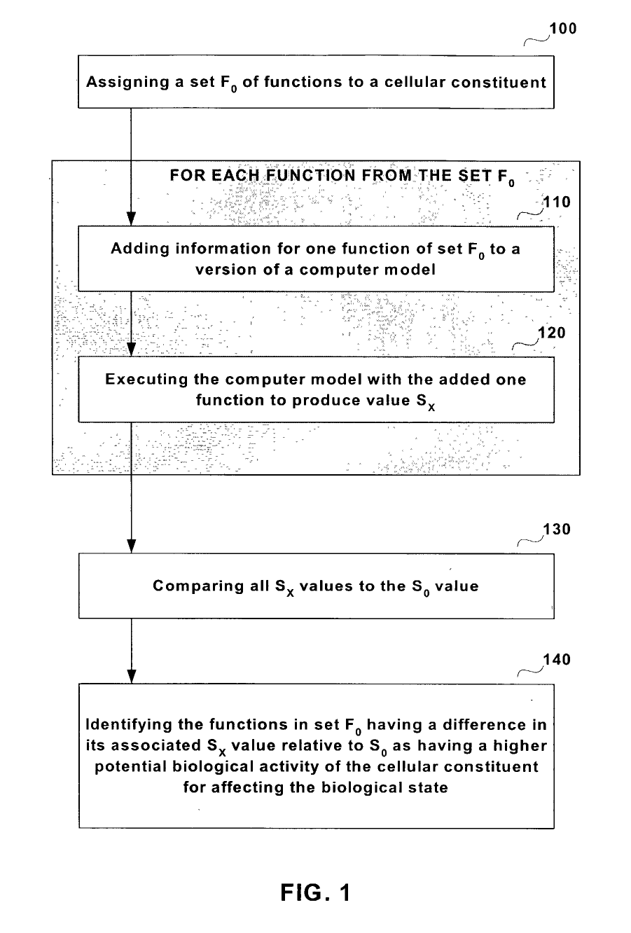

FIG. 1 shows a flowchart for predicting potential biological activity of a cellular constituent for affecting a biological state S, according to an embodiment of the invention. At step 100, a set F₀ of functions are assigned to the cellular constituent. Each function of set F₀ is a modification of at least one biological process of the biological state S. At step 110, the information for one function of set F₀ is added to a version of a computer model. At step 120, the computer model is executed with the added one function to produce value Sₓ for the biological state in the presence of the one function of set F₀. The steps 110 and 120 can be repeated for any other functions of set F₀. At step 130, all of the Sₓ values for functions of set F₀ are compared to an S₀ value. The S₀ value is obtained by executing the computer model in the absence of information of the functions of set F₀. At step 140, the functions in set F₀ having a difference in its associated Sₓ value relative to S₀ are identified as having a higher potential biological activity of the cellular constituent for affecting said biological state. The functions in set F₀ having no substantial difference in Sₓ value relative to S₀ are identified as having a lesser potential biological activity for affecting the biological state.

For the cellular constituent being evaluated, the user assigns a set of functions. The cellular constituent may be directly or indirectly involved in each function of the set of functions. The set of functions can comprise of one or more functions. /As used herein, the term “set” means a collection of distinct elements. The elements of a set are referred to as members of the set. The elements of a set can have common properties and the set can comprise of one or more elements. A function is a modification of at least one biological process that results from a change in at least one cellular constituent or a change in the physical property of the internal or external environment of the biological state. The modification can be either the execution or regulatory modulation of at least one of the biological processes determining the biological state. The modification can be up regulation or down regulation of one or more processes or cellular constituents, the inhibition, activation, or inactivation of processes; an increase or decrease of production and/or transport of cellular constituents; and increasing, decreasing, inactivation, or activation of the activity of cellular constituents.

The assigned set of functions is developed based on information known to the user and/or the information known in the art regarding the cellular constituent. The sources of this information can include experimental data, clinical data, knowledge/opinion of a person skilled in the art, simulation data, or other relevant sources.

For example, for a method of predicting the potential biological activity of gene X in asthma, the user can develop the set of functions using the following information—sequence homology of gene X with other known genes, presence or absence of gene X's product in diseased airway tissue, and polymorphisms in gene X in asthma patients compared to healthy individuals.

Note that the following description relating to steps 110 and 120 can be performed for other functions from the set of functions. In other words, steps 110 and 120 can be repeated for each function from the set of functions to produce a value Sₓ for each function of the set. Once a value Sₓ is produced for the functions from the set of functions, the process can proceed to step 130.

At step 110, the information of one function from the set of functions is added to a computer model of the biological state. The computer model comprises of individual biological processes associated with the biological state. For example, a computer model of asthma comprises of the following processes—transendothelial migration of inflammatory cell, production and release of inflammatory mediators, airway constriction, and production and release of mucus. The process of adding involves the modification of at least one of the processes of the computer model, based on the function being added. The computer model is configured to evaluate the effect of the biological processes on the biological state.

Adding the information may involve inputting the function of the cellular constituent into at least one of the processes in the computer model. The computer model, for example, can have at least one process that is modified by the function of the cellular constituent. Examples of the means for inputting the function into the computer model are provided in the following—Paterson et al., PCT application WO 99/27433; Paterson et al. PCT application, WO 00/63793; Paterson et al., U.S. Pat. No. 6,051,029; Paterson et al., U.S. Pat. No. 6,078,739; Paterson et al., U.S. Pat. No. 6,069,629. The disclosures of these references are herein incorporated by reference in their entirety. Other means will be readily apparent to a person of skill in the art.

The information regarding a particular function can be input into the computer model either explicitly or implicitly. Explicit input entails incorporation of one or more biological processes that are modified by the function into the computer model. Following this incorporation, the information for the function can be implicitly input into the computer model, as described below.

Means for implicit input will vary according to the computer model used to implement the methods of the invention. For example, in the commercially available Entelos® Asthma PhysioLab® systems, Entelos® Obesity PhysioLab® systems and Entelos® Adipocyte CytoLab™ systems, implicit input can entail hypothesizing which state nodes, function nodes, and links will be modified by the function and then changing the relevant state nodes, function nodes, and links. The state node then can be connected using links to other state nodes and also other function nodes, such that the information in the modified node changes the activity of the nodes to which it connects. The changing of the relevant state nodes, function nodes, and links can be done in a user-interface window that lists the baseline values of the parameters of interest of the nodes and links and allows new input to overwrite the baseline values. Types of parameters of interest include rates, initial state values, and whether the parameter is fixed or computed as the simulation progresses. Parameter values are increased or decreased from their baseline settings depending on the hypothesized functions of the cellular constituents. Further information on manipulating parameter values can be obtained from Paterson et al., U.S. Pat. No. 6,069,629. The disclosure of this reference is herein incorporated by reference in its entirety.

At step 120, the computer model with the added function is executed to produce a value for the biological state. The computer model can be executed with or without a virtual stimuli included in the computer model, thereby producing a value (also referred to herein as Sₓ) for the biological state. This value, as described previously, is a set of measurements of levels or activities of cellular constituents or measurements of observable and/or measurable behavior of the biological state which are referred to as the phenotype of the biological state. If a virtual stimulus is incorporated into the computer model, when the computer model is executed, the resulting value represents the response of the biological state to the virtual stimuli. If a virtual stimulus is not incorporated into the computer model, when the computer model is executed, the resulting value represents the on-going phenotype of the biological state.

For example, a model of an obese diabetic patient consuming 3 meals a day (55% carbohydrates, 30% fat, 15% protein) can be executed and the following measurements for a 24 hour period can be obtained—circulating levels of glucose (FIG. 8A), insulin (FIG. 8B), free fatty acids (FFA) (FIG. 8G), gluconeogenic precursors (FIG. 8E): lactate, amino acids, and glycerol, as well as the dynamics of processes like hepatic glucose output (FIG. 8C), muscle glucose uptake (FIG. 8D), relative contributions of whole body carbohydrate, fat and amino acid oxidation (FIG. 8H), and the expansion and depletion of the muscle and liver glycogen storage pools are also shown (FIG. 8F). In this case, based on the function being added, one or more of the processes can be modified and the model executed. The executing of the model in this case does not include a virtual stimulus. In another example, the Entelos® Asthma PhysioLab® systems can be executed while accounting for an allergen stimulus. In response to this virtual stimulus of allergen challenge, the following measurements can be obtained—airway conductance, eosinophil population in tissue, and levels of inflammatory mediators like histamine, bradykinin, cysteinyl leukotrienes, and prostaglandins. FIG. 6 depicts airway conductance in the form of first expiratory volume in one second (FEV₁) and levels of lipid mediators in response to an antigen challenge.

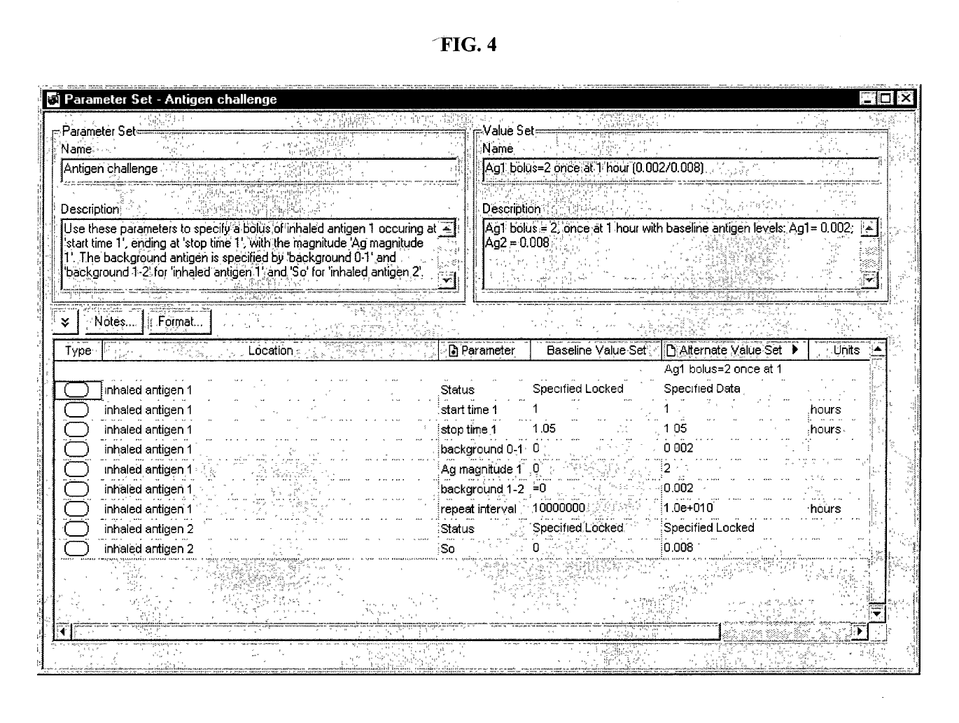

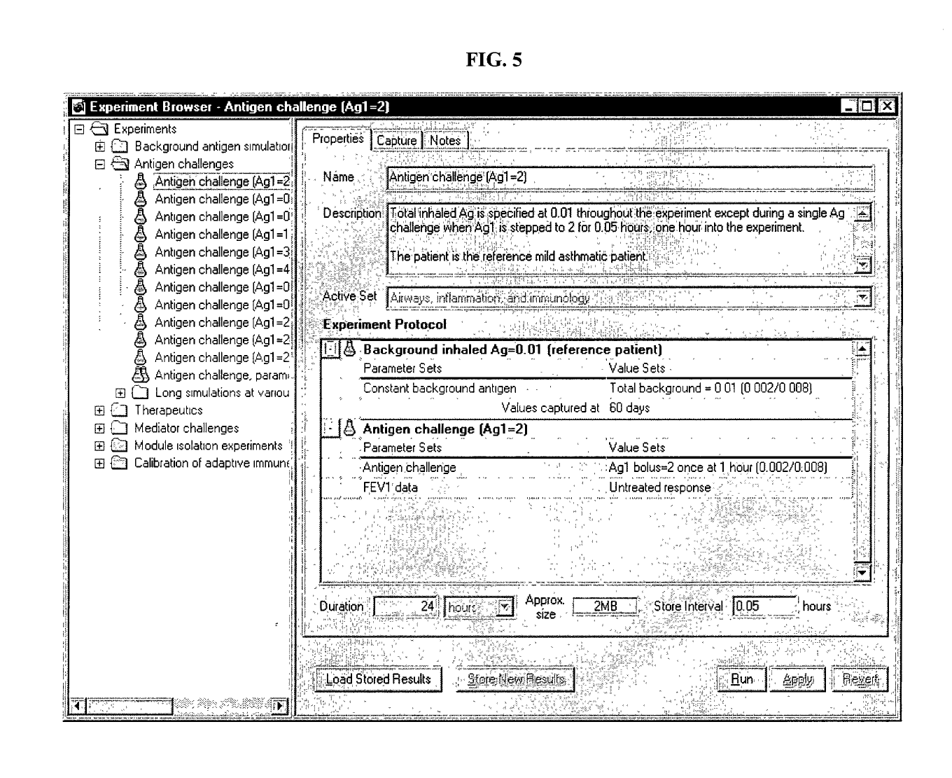

FIGS. 4 and 5 depicts an example of stimulating the Entelos® Asthma PhysioLab® systems with an allergen challenge. FIG. 4 depicts the parameter set for an allergen challenge. FIG. 5 depicts the experimental protocol for the allergen challenge. The parameter set is modified to define the allergen challenge and the computer model is executed. FIG. 6 depicts FEV₁ and levels of lipid mediators in response to this antigen challenge.

As mentioned above, the computer model that incorporates the function of the cellular constituent can be executed to obtain a value for the biological state. This value can represent, for example, the response of the biological state or the on-going phenotype of the biological state. This value is a set of measurements of levels or activities of cellular constituents or measurements of observable and/or measurable behavior of the biological state. The value is usually a set of observable and/or measurable phenomena. For example, in response to an antigen stimulus the value can comprise of the following measurements—level of transendothelial migration of inflammatory cells, amount of inflammatory mediators released, amount of airway constriction, and level of mucus release. The value can be computed dynamically over time.

The computer model can be executed with all or some of the functions of the set of functions of the cellular constituent incorporated into the model. The computer model can be executed without incorporating into the model any functions of the set of functions of the cellular constituents, to obtain a value for the biological state in the absence of any of the functions (also referred to herein as S₀). The version of the computer model that does not incorporate any function does not have to be executed concurrently with executing the computer model that incorporates the functions. The user can execute the computer model that does not incorporate any function at any time prior to or after executing the computer model that incorporates the functions. Once the user obtains the value of the state in the absence of any function, this value can be stored for future use. The value can be stored in the computer model being used.

At step 130, the value obtained for the biological state in presence of each function, Sₓ, is compared to the value obtained in the absence of the functions, S₀. Said another way, each Sₓ values for functions of the set F₀ is compared to the S₀ value obtained in the absence of any function of the set F₀. For a particular function, if the value obtained in the presence of the function, Sₓ, is different from the value obtained in the absence of the function, S₀, the function is identified as having a higher potential biological activity for affecting the biological state. If the value obtained in the presence of the function, Sₓ, is same or substantially same as the value obtained in the absence of the function, S₀, the function is identified as having a lesser potential biological activity of the cellular constituent for affecting the biological state.

At step 140, the functions having a difference in its associated Sₓ value relative to S₀ are identified as having a higher potential biological activity of the cellular constituent for affecting the biological state. Said another way, the potential biological activity predicted depends on the difference between the value obtained in the presence of the function, Sₓ, and the value obtained in the absence of the function, S₀. The value obtained is generally a set of measurements, the set consisting of one or more measurements. The measurement from the value in the presence of the function is compared to a corresponding measurement from the value in the absence of the function. The set of measurements consists of measurements of levels or activities of cellular constituents or measurements of observable and/or measurable behavior of the biological state. For example, in an obesity model, the values obtained can include measurements of levels of leptin in the plasma. If the function assigned to a cellular constituent is the modification of free fatty acid levels in plasma, in the computer model the free fatty acid level in plasma is modified and the computer model is executed and the level of leptin in plasma is obtained. The computer model is also executed without modifying the level of free fatty acid in plasma. The levels of leptin with and without modification of free fatty acid levels are compared to decide whether the function of modification of free fatty acid levels is a potential biological activity of the cellular constituent to affect the state of obesity. The user decides what set of differences between the values for the biological states will indicate a potential biological activity of the cellular constituent to affect the state of obesity. This set of differences can comprise of one or more numerical or non-numerical values.

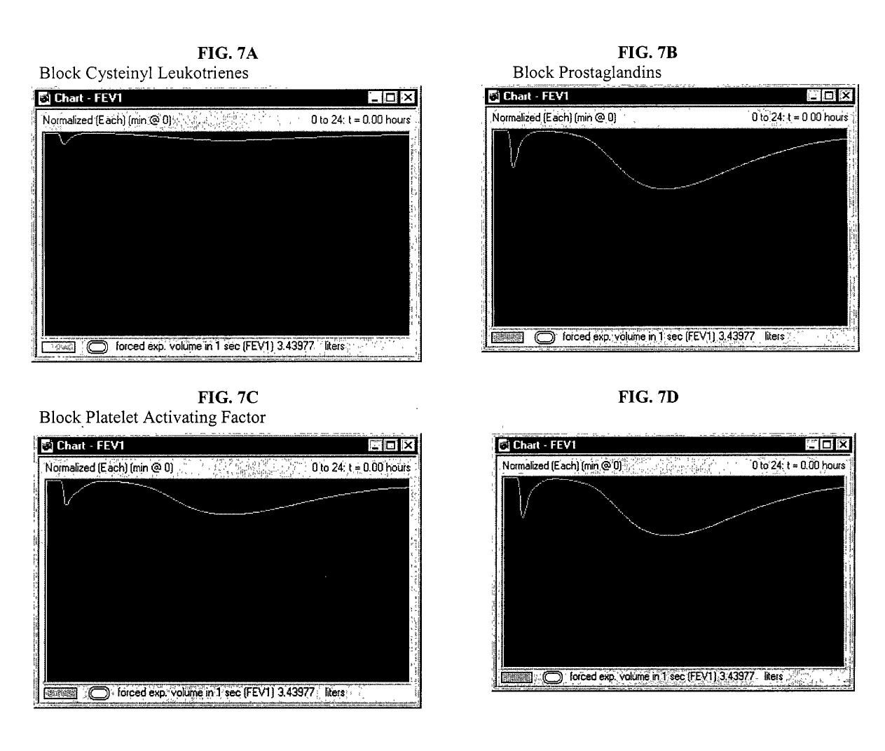

For example, as described in Example 2 and depicted in FIGS. 7A, 7B, 7C, and 7D, FEV₁ value in the presence of blocking of prostaglandins and platelet activating factor (PAF) showed a small improvement compared to when these two biological processes were not modified. But, this small improvement would not have resulted in an improvement in airway conductance in an asthmatic patient. However, when cysteinyl leukotrienes were blocked, the FEV₁ value was different from the FEV₁ value obtained when this biological process was not modified. Hence, the 5-lipoxygenase gene was confirmed as having a potential for affecting the clinical outcome of an asthmatic patient.

The method for predicting potential biological activity of a cellular constituent for affecting a biological state can further comprise: obtaining experimental information on biological activity of said cellular constituent for at least one individual biological process in said computer model; adding said experimental information to said computer model; re-evaluating S_{X} values for each of said functions of set F₀; and using said re-evaluated S_{X} values to re-order, if necessary, priority of scientific investigation on functions of cellular constituents for ability to affect said biological state. The methods of this invention can also be used to prioritize scientific investigation on drugs.

For example, after predicting the potential biological activity of a novel gene for affecting a biological state, the novel gene is considered to have a possibility of being biologically relevant in the biological state being studied. Next, the putative functions of the novel gene can be tested in vivo or in vitro to determine whether the identified potential biological activities are related to the novel gene in the biological state being evaluated. The in vivo or in vitro testing can be preformed using biological assay systems known in the art. Biological assay systems include cell-based assays and animal models. The cell-based assays can be preformed with either acute cultures, i.e. surgically removed from human or animal tissue and then cultured in a dish, or cell line cultures, i.e. cells that have been transformed to immortalize them may be used. Cells may be from normal humans or humans suffering from a disease being studied and the non-human mammals may be rats, mice, and so forth. For example, cells from normal non-human mammals or non-human mammals that are animal models of obesity or diabetes may be used. For example, cells from homozygous obese (ob), diabetic (db), fat (fat) or tubby (tub) mice may be used. Animal models can be non-human models like mice, rats, and so forth. The animal models used can include models of diseases being studied. For example, animal models of obesity or diabetes like homozygous obese (ob), diabetic (db), fat (fat) or tubby (tub) mice may be used.

For example, the levels of the product of a novel gene can be modulated in a suitable cell culture system. The levels can be decreased using antisense or ribozyme approaches, or treatments that affect transcription, translation, protein modifications, or translocations, or protein degradation pathways. Their levels can be increased using gene replacement techniques, epigenic techniques, or with cells expressing the appropriate gene product activity. Using these approaches, the effect of a novel gene on a biological state can be confirmed. If, for example, in a biological assay system, a new function for the novel gene is identified This new information can be incorporated into the computer model and new values for the biological state can be obtained in the presence of the novel gene.

Methods of this embodiment of the invention can produce a value for each function for a biological state. Thus, each function of the set of functions can be ordered based on this value. The order can represent the potential likelihood that a particular function for a particular cellular constituent will have for affecting a biological state. Further, scientific investigation of the biological activity of the cellular constituent can be based on this order. One form of scientific investigation involves the identification of potential drug targets for different disease states.

In another embodiment of the invention, the potential biological activity of polynucleotides and polypeptides for affecting a biological state can be determined. Polynucleotides include polymeric forms of nucleotides of any length, either ribonucleotides or deoxyribonucleotides, or analogs thereof. This term refers to the primary structure of the molecule, and thus includes double- and single-stranded DNA, as well as double- and single-stranded RNA. It also includes modified polynucleotides such as methylated and/or capped polynucleotides. The term “gene” refers to a polynucleotide or portion of a polynucleotide comprising a sequence that encodes a protein. It is well understood in the art that a gene also comprises non-coding sequences, such as 5′ and 3′ flanking sequences (such as promoters, enhancers, repressors, and other regulatory sequences) as well as introns. Polypeptides, peptides, and proteins can be used interchangeably herein to refer to polymers of amino acids of any length. These terms also include proteins that are post-translationally modified through reactions that include glycosylation, acetylation and phosphorylation.

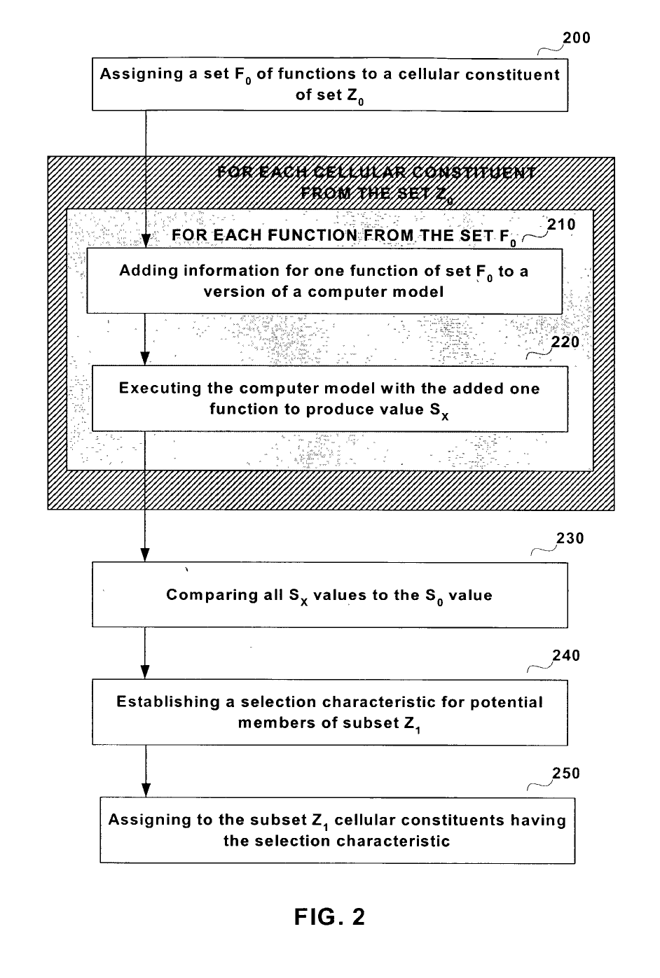

FIG. 2 shows a flowchart for selecting a subset Z₁ of cellular constituents having a potential biological activity for affecting biological state S from a set Z₀ of cellular constituents, according to an embodiment of the invention. In this embodiment, the user starts with a set of cellular constituents that have a potential biological activity for affecting a biological state. The set of functions and set of cellular constituents comprise of one or more members. Using this method, the user is able to prioritize the functions of each cellular constituent and also prioritize the cellular constituents. This priority can be used to determine the priority of scientific investigation on cellular constituents and/or functions of cellular constituents.

Using this method, the user is able to create a subset of cellular constituents having a potential biological activity for affecting a biological state from the set of cellular constituents. The subset can have zero members from the set, all members from the set, or any combination of members from the set.

At step 200, a set F₀ of functions are assigned to the cellular constituents of set Z₀. Each function is a modification of at least one biological process of the biological state S.

Note that the following description relating to steps 210 and 220 can be performed for each function from the set of functions (e.g., a function set F₀) and then this overall process can be repeated for each cellular constituent from the set Z₀. In other words, each cellular constituent from the set Z₀ is associated with its own set of functions F₀; for each cellular constituent from the set Z₀ and for set function from the functions F₀ for a given cellular constituent, steps 210 and 220 are repeated to an original version of the computer model to produce a value Sₓ. Once a value Sₓ is produced for each function for each cellular constituent, the process can proceed to step 230.

At step 210, information for one of the functions of set F₀ for one of the cellular constituents of set Z₀ is added to a computer model of the biological state. The computer model represents individual biological processes associated with the biological state. At least one of the individual biological processes is a process modified by the one function of set F₀. The computer model is configured to evaluate the effect of modifying the individual biological processes on the biological state.

At step 220, the computer model with the added one function of set F₀ of the one cellular constituent is executed to produce value S_{X} for the biological state in the presence of the one function of set F₀ of the one cellular constituent.

At step 230, all of the S_{X} values for cellular constituents in set Z₀ are compared to a S₀ value. The S₀ value is produced by executing the computer model in the absence of any of the functions of any of the cellular constituents.

At step 240, a selection characteristic for potential members of a subset Z₁ from the cellular constituent set Z₀ is established. As used herein, the term “selection characteristic” means a criteria developed by the user. The selection characteristic represents the desired results on the biological state being studied. This criteria depends on the method practiced by the user. In one embodiment, the selection characteristic comprises of a set of difference values. A difference value can be a difference between the values being compared, for example, between Sₓ values for cellular constituents in set Z₀ to the value S₀. The set of difference values can consist of a series of difference values.

For example, to predict the role of a novel gene Y in asthma symptoms, one of the functions assigned to the novel gene is the production of bradykinin. In a computer model of asthma, without modifying the processes related to bradykinin, a virtual patient is exposed to an allergen challenge and the value for the state obtained comprises of measurement of airway conductance. Next, the activity of bradykinin is blocked in the computer model, and the virtual patient is exposed to an allergen challenge and the measurement of airway conductance is obtained. The selection characteristic developed by the user in this example will contain one parameter, i.e. measurement of airway conductance. This parameter can have a set of values, each value being a difference in airway conductance with and without the blocking of bradykinin. The differences, i.e. values for the parameter, can be a series of percentage increases (for example, 50% -100%) in airway conductance when the activity of bradykinin is blocked. Thus, if airway conductance is increased by 75% when the activity of bradykinin is blocked compared to when the activity is not blocked, this function meets the selection characteristic of the user and the user can predict that the modulation of bradykinin production during an asthma attack by novel gene Y is relevant to the disease state of asthma. Further, the user can also perform studies of novel gene Y in biological assay systems to confirm that the identified bradykinin activity is related to novel gene Y. Based on the results from the computer model and/or biological assay systems, the user can assign a higher priority to novel gene Y for its evaluation as a potential drug target for asthma.

At step 250, cellular constituents having the selection characteristic are assigned to the subset Z₁. In other words, the selection characteristic is used to determine the members of the subset. The selection characteristic can be based on the difference between the values Sₓ and S₀ for the biological states. This value can be a set of measurements of levels or activities of cellular constituents and measurements of observable and/or measurable behavior of the biological state. The selection characteristic can be defined by the user. Typically, the selection characteristic defined by the user is related to a desired clinical outcome in the disease state being evaluated. The selection characteristic can be based on a difference between Sₓ and S₀ values or can be based on general trends in the values. A user's selection characteristic can be based on some or all measurements in the values. Typically, a function of a cellular constituent can result in the activation or inactivation of other cellular constituents or processes. This activation or inactivation can be reflected in certain measurements in the Sₓ and S₀ values. In this instance, the selection characteristic will be either the activation or inactivation of the cellular constituents or processes, and this activation or inactivation can be observed by comparing the pertinent measurements in the Sₓ and S₀ values. In other instances, a function of a cellular constituent can result in the increase or decrease in levels of other cellular constituents. This increase or decrease in levels can be reflected not only in measurements of the cellular constituents, but also by observing and/or measuring behaviors modified by the cellular constituents. In this instance, the selection characteristic will be either the increase or decrease in levels of the cellular constituents, and this increase or decrease can be observed by comparing the pertinent measurements in the Sₓ and S₀ values.

In one embodiment of the invention, the cellular constituents in subset Z₁ can be further evaluated as described below. In this embodiment, the relationship between each cellular constituent and its functions are evaluated using biological assay systems. The cellular constituent of subset Z₁ being evaluated is perturbed in a biological assay system. In particular, the biological assay system is a system that is appropriate to investigate the link between the cellular constituent and its functions. For example, for novel gene Y the biological assay system would be one that is appropriate to evaluate the relationship between novel gene Y and bradykinin production in the disease state of asthma. The biological assay system is executed in the presence of the perturbed cellular constituent to produce a set of function values. The set of function values consists of one or more function values FVₓ, each FVₓ value being related to at least one function of the cellular constituent being evaluated. The function value is a numerical or non-numerical value that quantifies the effect of the perturbation of the cellular constituent on one or more of the functions assigned to the cellular constituent. The function value can be quantified by measuring the effect on the biological process that is modified by the function being quantified. The effect on the biological process can be quantified by measuring the levels or activities of a cellular constituent related to the biological process. Techniques for measuring the levels or activities of cellular constituents are well known in the art, some of these techniques are described below. The function values FVₓ are obtained in the presence of the perturbed cellular constituent. Each FVₓ value is compared to a corresponding FV₀ value. The FV₀ value is obtained by executing the biological assay system in the absence of perturbation of the cellular constituent. For the cellular constituent, similar to the FVₓ values, a set of FV₀ values are obtained. Thus, for each function of a cellular constituent, a FVₓ and a FV₀ value is obtained. In the comparison step, for each function the FVₓ and FV₀ values are compared. A selection characteristic for potential members of subset Z₂ from the subset Z₁ is established. Cellular constituents having the selection characteristic are assigned to subset Z₂. The selection characteristic in this embodiment of the invention is based on the difference between FVₓ and FV₀ values for each function of the cellular constituent being evaluated. The selection characteristic can be a range of differences between the values. For example, if the function values (FVₓ and FV₀) for a particular function is the activity of a cellular constituent, the selection characteristic can be a range of differences in the activity of the cellular constituent, before and after perturbation of the cellular constituent being evaluated. The selection characteristic correlates the effect of the perturbation of the cellular constituent being evaluated on at least one of the functions of set F₀ of the cellular constituent. Thus, a cellular constituent assigned to subset Z₂ is identified as a cellular constituent that has a high potential of affecting the biological state being evaluated. The cellular constituents without the selection characteristic are considered to have a low potential for affecting the biological state. It would be apparent to one of skill in the art that different biological assay systems may be necessary to evaluate the different cellular constituents of subset Z₁.

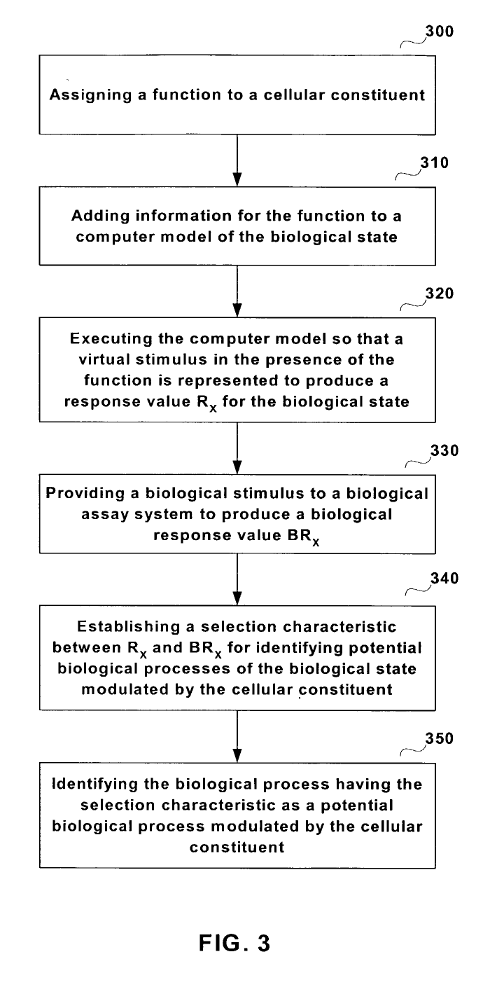

FIG. 3 shows a flowchart for identifying potential biological processes of a biological state modulated by a cellular constituent, according to an embodiment of the invention. At step 300, a function is assigned to a cellular constituent. The function is a modification of at least one biological process of the biological state. At step 310, information for the function is added to a computer model of the biological state. The computer model represents individual biological processes associated with the biological state. At least one of the individual biological processes is a process modified by the function. The computer model is configured to evaluate the effect of modifying the biological processes on the biological state.

At step 320, the computer model representing a virtual stimulus in the presence of the function is executed to produce a response value Rₓ for the biological state in the presence of the function. At step 330, a biological stimulus is provided to a biological assay system to produce a biological response value (also referred to herein as BRₓ). The biological stimulus is the biological equivalent of the virtual stimulus and the biological assay system is the biological equivalent of the biological state. Consequently, a user can compare the response value obtained from the computer model (also referred to herein as Rₓ) to the response value obtained from a biological assay system (also referred to herein as BRₓ).

Many biological assay systems are known in the art. Biological assay systems include cell-based assays and animal models. The cell-based assays can be preformed with either acute cultures, i.e. surgically removed from human or animal tissue and then cultured in a dish or cell line cultures, i.e. cells that have been transformed to immortalize. Cells may be from normal humans or humans suffering from a disease being studied or from non-human mammals like rats, mice, and so forth. For example, cells from normal non-human mammals or non-human mammals that are animal models of obesity or diabetes may be used. For example, cells from homozygous obese (ob), diabetic (db), fat (fat) or tubby (tub) mice may be used. Animal models can be non-human models like mice, rats, and so forth. The animal models used can include models of diseases being studied. For example, animal models of obesity or diabetes like homozygous obese (ob), diabetic (db), fat (fat) or tubby (tub) mice may be used.

In one embodiment of the invention, the biological assay system employed in the present invention is a biological equivalent of the biological state represented by the computer model. For example, for the biological state of obesity, the computer model can represent an obese patient and the biological assay system used can be a homozygous obese (ob) mice which is an animal model of obesity. It is not required that the computer model represent all the biological processes of the biological assay system. Also, as would be apparent to a person of skill in the art, the term “biological equivalent” as used herein does not mean exactly the same or identical. It is not necessary the biological assay system contain all the processes modeled in the computer model. For example, for the biological state of obesity, the computer model can represent an obese patient and the biological assay system used can be acutely cultured cells from a homozygous obese (ob) mice. The biological assay system and computer model employed can depend on the response values being studied. For example, for the biological state of obesity, if the response value being studied is the release of leptin from adipocytes, the computer model can be a model of adipocytes or a model of obesity that includes adipocyte function and the biological assay system can be either a cell culture of adipocytes or an animal model in which the release of leptin from adipocytes can be measured. Also, the biological assay system and computer model employed can depend on the cellular constituent and the function assigned to the cellular constituent.

The term “stimulus” as used herein means an agent or environmental change that produces a change in all or some of the biological processes of a biological state. A “virtual stimulus” is employed in a computer model, whereas a biological stimulus is employed in a biological assay system. The biological stimulus employed in the present invention is the biological equivalent of the virtual stimulus that is represented by the computer model. For example, for the biological state of asthma, if an allergen is the virtual stimulus for the computer model, then the biological stimulus used could also be an allergen. In another example, if the levels of free fatty acids are changed in a computer model of an adipocyte, then in the biological assay the levels of free fatty acid are changed. However, as would be apparent to a person of skill in the art, the term “biological equivalent” as used herein does not mean exactly the same or identical. The biological stimulus and the virtual stimulus can be similar in effect and/or function. If an allergen is the virtual stimulus, the biological stimulus used can be any stimulus which has the same effect or function as the stimulation with an allergen. Thus, the biological stimulus can include an allergen, an agent that causes degranulation of mast cell, or any other agent that has the same effect or function as the allergen.

At step 340, a selection characteristic to identify potential biological processes of the biological state modulated by the cellular constituent is established. For example, the user can define the selection characteristic. The selection characteristic is based on the difference between the response value obtained from the computer model and the biological response value obtained from the biological assay system. For example, the selection characteristic can be a range of differences between, for example, the response value Rₓ and the biological response value BRₓ. A user's selection characteristic can be based on some or all measurements in the response value and biological response value. Typically, if the computer model and the biological assay system behave in a corresponding manner, the biological process is considered to have a high potential of being modulated by the cellular constituent in the biological state being evaluated.

At step 350, the biological process having the selection characteristic is identified as a potential biological process modulated by the cellular constituent. Typically, a function of a cellular constituent can result in the activation or inactivation of other cellular constituents or processes. This activation or inactivation can be reflected in certain measurements in the response value and biological response value. In this instance, the selection characteristic will be either the activation or inactivation of the cellular constituents or processes in both the response value and biological response value. Typically, the activation or inactivation can be observed by comparing the pertinent measurements in the response value and biological response value. In other instances, a function of a cellular constituent can result in the increase or decrease in levels of other cellular constituents. This increase or decrease in levels can be reflected not only in measurements of the cellular constituents, but also by observing and/or measuring behaviors modified by the cellular constituents. In this instance, the selection characteristic will be either the increase or decrease in levels of the cellular constituents in both the response value and biological response value. Typically, the increase or decrease can be observed by comparing the pertinent measurements in the response value and biological response value.

One embodiment of the invention is a method for predicting biological processes involved in the action of a drug in a disease state. This embodiment of the invention allows an user to predict the biological processes that are involved in the action~of a drug. Embodiments of the invention can be used to predict biological processes that mediate the therapeutic effects of a drug or biological processes that mediate the side-effects of a drug. In many instances, a particular drug produces the desired therapeutic effect, but also produces unwanted side-effects. The embodiments of this invention can be used to predict the biological processes involved in these unwanted side-effects. Very often, drugs produce the desired effects, however, their mechanism of action is not understood. A better understanding of the mechanism of action can help in the modification of the structure of the initial drug to synthesis drugs with improved potency or efficacy.

The biological response value for a biological assay system can be obtained, for example, by measurements of levels or activities of cellular constituents and/or measurements of measurable behavior of the biological state. The transcription, translation, and/or activities of cellular constituents can be measured.

The measurement of transcription of cellular constituents can be performed, for example, using any probe or probes which comprise a polynucleotide sequence and which are immobilized to a solid support or surface. For example, the probes may comprise DNA sequences, RNA sequences, or copolymer sequences of DNA and RNA. The polynucleotide sequences of the probes may also comprise DNA and/or RNA analogues, or combinations thereof. The polynucleotide sequences of the probes may also be synthesized nucleotide sequences, such as synthetic oligonucleotide sequences. The probe sequences can be synthesized either enzymatically in vivo, enzymatically in vitro, (e.g., by polymerase chain reaction (PCR), or non-enzymatically in vitro. The probe or probes used in the embodiments of the invention can be immobilized to a solid support or surface which may be either porous or non-porous. For example, the probes may be polynucleotide sequences which are attached to a nitrocellulose or nylon membrane or filter. Such hybridization probes are well known in the art (see, e.g., Sambrook et al., Eds., 1989, Molecular Cloning: A Laboratory Manual, 2nd ed., Vols. 1-3, Cold Spring Harbor Laboratory, Cold Spring Harbor, N.Y.). Alternatively, the solid support or surface may be a glass or plastic surface. Measurement of the transcription are made by hybridization to microarrays of probes consisting of a solid phase, on the surface of which are immobilized a population of polynucleotides, such as a population of DNA or DNA mimics, or, alternatively, a population of RNA. A microarray comprises a surface with an ordered array of binding (e.g., hybridization) sites for products of many of the genes in the genome of the biological state, for example, most or almost all of the genes.

The measurement of translation of cellular constituents can be performed according to several methods. For example, whole genome monitoring of protein (i.e., the “proteome,” Goffea et al., supra) can be performed by constructing a microarray in which binding sites comprise immobilized, monoclonal, antibodies specific to a plurality of protein species encoded by the cell genome. Antibodies can be present for a substantial fraction of the encoded proteins, or at least for those proteins relevant to the action of a drug of interest. Methods for making monoclonal antibodies are well known (see, e.g., Harlow and Lane, 1988, Antibodies: A Laboratory Manual, Cold Spring Harbor, N.Y.). In one embodiment, monoclonal antibodies are raised against synthetic peptide fragments designed based on genomic sequence of the cell. With such an antibody array, proteins from the cell are contacted to the array, and their binding is assayed with assays known in the art. Alternatively, proteins can be separated by two-dimensional gel electrophoresis systems. Two-dimensional gel electrophoresis is well known in the art, and typically involves iso-electric focusing along a first dimension followed by SDS-PAGE electrophoresis along a second dimension. See, e.g., Hames et al., 1990, Gel Electrophoresis of Proteins: A Practical Approach, IRL Press, New York; Shevchenko et al., 1996, Proc. Natl. Acad. Scie. U.S.A. 93:1440-1445; Sagliocco et al., 1996, Yeast 12:1519-1533; and Lander, 1996, Science 274:536-539. The resulting electropherograms can be analyzed by numerous techniques, including mass spectrometric techniques, western blotting, and immunoblot analysis using polyclonal and monoclonal antibodies, and internal and N-terminal micro-sequencing. Using these techniques, it is possible to identify a substantial fraction of all the proteins produced under given physiological conditions, including in cells (e.g., in yeast) exposed to a drug, or in cells modified by, e.g., deletion or over-expression of a specific gene.

Activities of cellular constituent, like proteins, can be measured and embodiments of this invention can be based on such measurements. Activity measurements can be performed by any functional, biochemical, or physical means appropriate to the particular activity being characterized. Where the activity involves a chemical transformation, the cellular protein can be contacted with the natural substrate(s), and the rate of transformation measured. Where the activity involves association in multimeric units, for example association of an activated DNA binding complex with DNA, the amount of associated protein or secondary consequences of the association, such as amounts of mRNA transcribed, can be measured. Also, where only a functional activity is known, for example, as in cell cycle control, performance of the function can be observed.

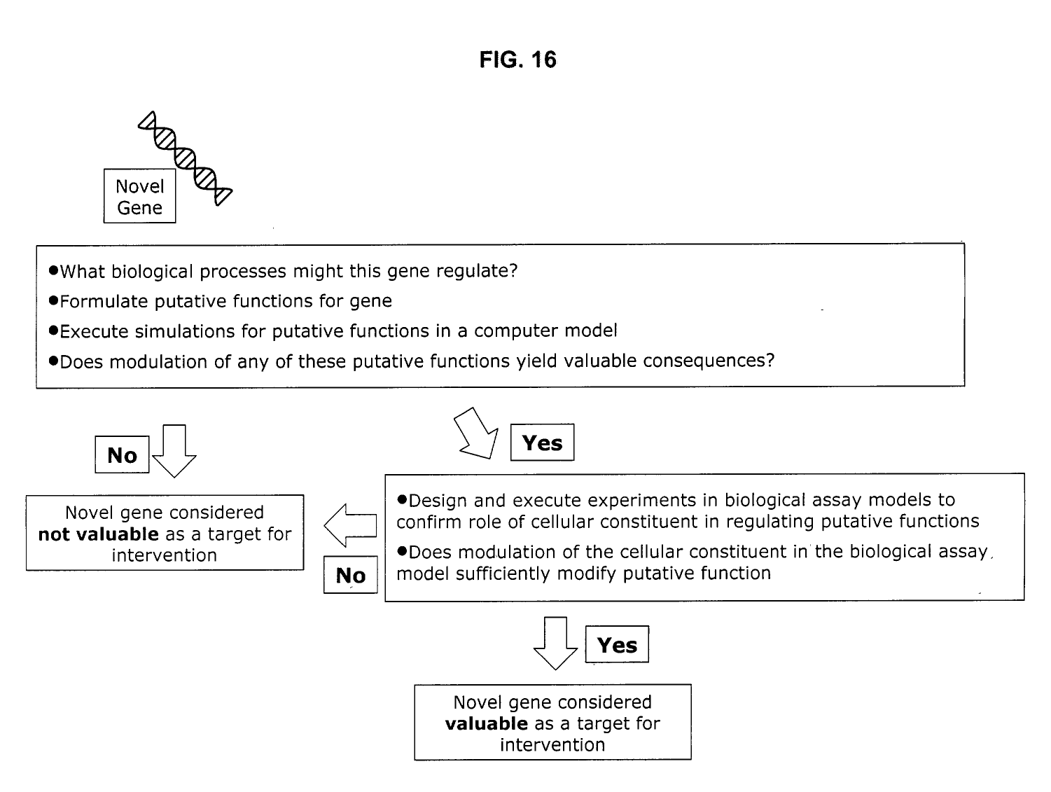

In one embodiment of the invention, the methods of the present invention are used to identify cellular constituents that can be used as targets for the development of therapies for various disease states. FIG. 16 depicts a method for identifying whether a novel gene can be used as a drug target. The user uses information known in the art and/or information known to the user to identify biological processes that may be regulated by the novel gene. Based on the biological processes identified, the user formulates putative functions for the novel gene. These putative functions are then tested in a computer model of the biological state in which the gene is hypothesized to play a role. This testing can be performed using the methods described in the present invention. This testing determines whether any of the putative functions of the novel gene have a potential for affecting the biological state in which the novel gene is hypothesized to play a role. If the computer model indicates that the putative functions do not affect the biological state, the novel gene is not further evaluated as a drug target. If one or more of the putative functions affect the biological state, then the novel gene is further evaluated as a drug target. The user next attempts to link the identified putative functions to the novel gene being, evaluated. That is, the user confirms the existence of a relationship between the identified functions and the novel gene. In one embodiment of the invention, this verification is performed using biological assay systems. The novel gene is perturbed in a biological assay system and the effect of this perturbation is evaluated by measuring the effect on the identified functions. Several techniques for perturbation of a novel gene are known in the art. For example, the novel gene can be perturbed by modulating the levels of the product of the novel gene in a suitable cell culture system. The levels can be decreased using antisense or ribozyme approaches, or treatments that affect transcription, translation, protein modifications, or translocations, or protein degradation pathways. The novel gene can also be perturbed by increasing the levels of the product of the novel gene using gene replacement techniques, epigenic techniques, or with cells expressing the appropriate gene product activity. The effect of the perturbation on the functions can be obtained by measuring the effect on the biological process related to the function. The effect on the biological process is most suitably obtained by measurements of levels or activities of cellular constituents related to the biological process. Techniques for measuring levels or activities of cellular constituents are well known in the art, some of these techniques are described above. The functions that are modified by the perturbation to the novel gene are confirmed to be functions that have a high potential of being related to the novel gene. If one or more hypothesized functions are modified by the perturbation of the novel gene, the novel gene is further evaluated as a drug target. If no functions are modified, the novel gene is not further evaluated.

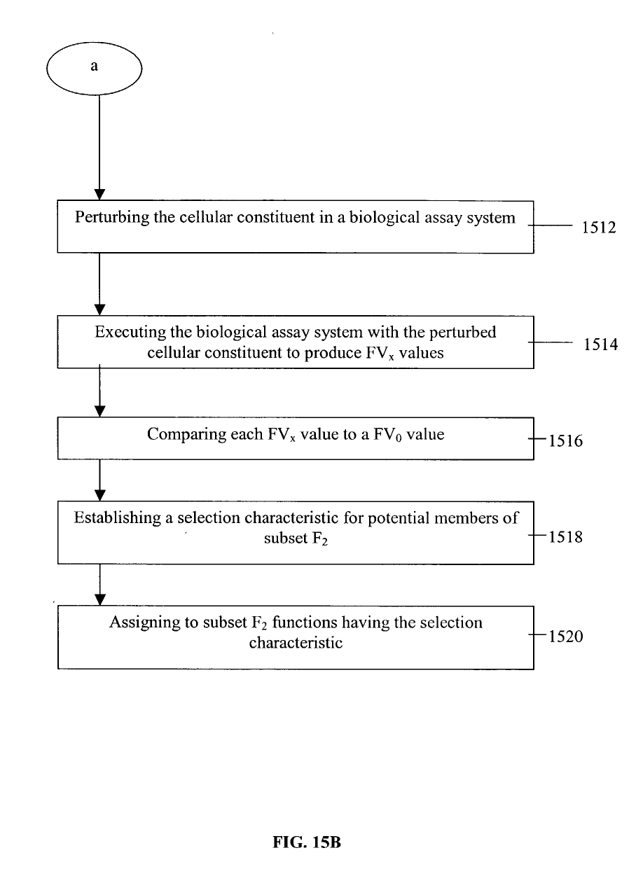

FIG. 15A depicts a flowchart illustrating a method for predicting potential biological activity of a cellular constituent for affecting a biological state S. Based on the potential biological activity of the cellular constituent, the cellular constituent can be further evaluated for development as a drug target. At step 1500, a set F₀ of functions is assigned to a cellular constituent. Each function of the set F₀ of functions is a modification of at least one biological process of the biological state S. At step 1502, information for one functions of the set F₀ is added to a computer model of the biological state S. The computer model represents individual biological processes associated with the biological state. At least one of the individual biological processes is a process modified by the function. The computer model is configured to evaluate the effect of modifying the biological processes on the biological state. At step 1504, the computer model is executed with the added one function to produce value Sₓ in the presence of the one function of set F₀. The steps 1502 and 1504 can be repeated for any other functions of set F₀. At step 1506, all the Sₓ values for functions of set F₀ are compared to a S₀ value. The S₀ value is obtained by executing-the computer model in the absence of information of the functions of set F₀. At step 1508, a selection characteristic for potential members of subset F₁ from the set F₀ is established. At step 1510, functions having the selection characteristic are assigned to subset F₁.

As mentioned previously, the selection characteristic represents the desired results on the biological state being studied. In one embodiment, the selection characteristic can be a series of difference values between the Sₓ values and S₀ value. The selection characteristic is correlated to the potential biological activity of the cellular constituent for affecting a biological state. Thus, the functions included in subset F₁ have a higher potential of affecting the biological state than the functions not included in this subset.

In another embodiment of the invention, the functions in subset F₁ can be further evaluated as described in FIG. 15B. FIG. 15B depicts a method of the invention for creating a further subset F₂ of subset F₁. The relation between the cellular constituent and the functions of subset F₁ are evaluated using biological assay systems. The functions of subset F₁ that are identified as having a high likelihood of being related to the cellular constituent are assigned to subset F₂. At step 1512, the cellular constituent being evaluated is perturbed in a biological assay system. This biological assay system can be the biological equivalent of the biological state being evaluated. In particular, the biological assay system is a system that is appropriate to investigate the link between the cellular constituent and the putative function being evaluated. Several techniques are known in the art for perturbing a cellular constituent. For example, if the cellular constituent is a polypeptide, it can be perturbed by increasing or decreasing its activity or levels. The activity can be increased or decreased using agonists or antagonists. The levels can be increased or decreased by interfering with transcription or translation of the polypeptide. Methods for perturbation of a polynucleotide are also well known in the art, some of which are described above. At step 1514, the biological assay system is executed in the presence of the perturbed cellular constituent to produce a set of function values. The set of function values consists of one or more function values FVₓ, each FVₓ value being related to one function of subset F₁. The function value is a numerical or non-numerical value that quantifies the effect of the perturbation of the cellular constituent on one of the functions assigned to the cellular constituent. The function value can be quantified by measuring the effect on the biological process that is modified by the function being quantified. The effect on the biological process can be quantified by measuring the levels or activities of a cellular constituent related to the biological process. Techniques for measuring the levels or activities of cellular constituents are well known in the art, some of these techniques are described above. The function values FVₓ are obtained in the presence of the perturbed cellular constituent. At step 1516, each FVₓ value is compared to a corresponding FV₀ value. The FV₀ value is obtained by executing the biological assay system in the absence of perturbation of the cellular constituent. For the cellular constituent, similar to the FVₓ values, a set of FV₀ values are obtained. Thus, for each function of subset F1, a FVₓ and a FV₀ value is obtained. In the comparison step, i.e., step 1516, for each function the FVₓ and FV₀ values are compared. At step 1518, a selection characteristic for potential members of subset F₂ from the subset F₁ is established. At step 1520, functions having the selection characteristic are assigned to subset F₂. The selection characteristic in this embodiment of the invention is based on the difference between FVₓ and FV₀ values for each function. The selection characteristic can be a range of differences between the values. For example, if the function values (FVₓ and FV₀) for a particular function is the activity of a cellular constituent. The selection characteristic can be a range of differences in the activity of the cellular constituent, before and after perturbation of the cellular constituent being evaluated. The selection characteristic correlates the effect of the perturbation of the cellular constituent being evaluated to the functions of subset F₁. A function that has the selection characteristic is identified as a function that has a high potential of being related to the cellular constituent being evaluated. The functions without the selection characteristic are considered to have a low potential for being related to the cellular constituent. If no functions are assigned to subset F₂, then none of the functions of set F₀ have a potential for being related to the cellular constituent being evaluated. It would be apparent to one of skill in the art that different biological assay systems may be necessary to evaluate the different functions of subset F₁.

Implementation Systems and Methods

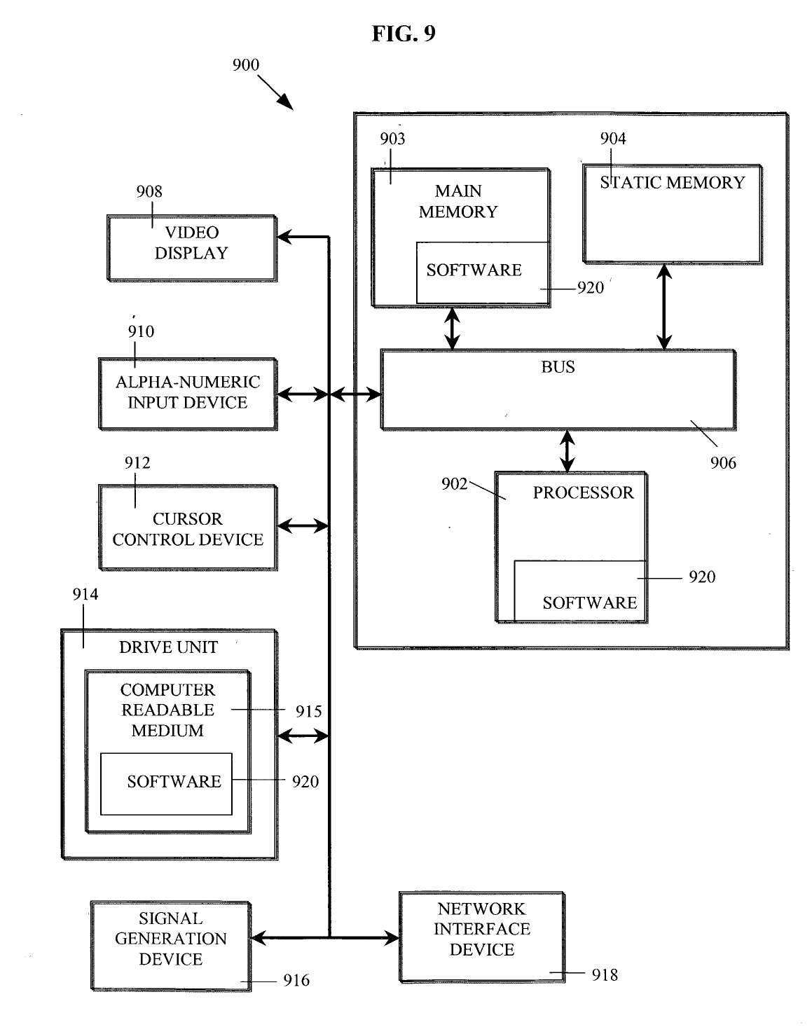

The methods described in the previous sections can be implemented by a computer system. FIG. 9 illustrates an example of a computer system suitable for implementation of the above-described methods. The computer system 900 includes a processor 902, a main memory 903 and a static memory 904, which communicate via a bus 906. This system 900 is further shown to include a video display unit 908 (e.g., a liquid crystal display (LCD) or a cathode ray tube (CRT)) on which a biological state or disease state according to the present invention may be displayed. The computer system 900 also includes an alpha-numeric input device 910 (e.g. a keyboard), a cursor control device 912 (e.g. a mouse), a disk drive unit 914, a signal generation device 916 (e.g. a speaker) and a network interface device 918. The disk drive unit 914 includes a computer-readable medium 915 on which software 920 for executing each methodology described above is stored. The software 920 is also shown to reside, completely or at least partially, within the main memory 903 and/or within the processor 902. The software 920 may further be transmitted or received via the network interface device 918. For the purposes of this specification, the term “computer-readable medium” shall be taken to include any medium which is capable of storing or encoding a sequence of instructions for performing the methodologies of the present invention, and shall be taken to included, but not be limited to, optical and magnetic disks, and carrier wave signals.

Note that the above-described methods can be implemented entirely within computer software or through the combination of some steps performed through computer software and the remaining steps performed through a user of the computer software. For example, the steps of comparing the values Sₓ for a biological state in the presence of an added function of set F₀ to the value S₀ for a biological state without any added functions can be performed automatically within computer software or can be performed by a user that is executing the computer software to obtain the specific values of Sₓ and S₀.

Embodiments the above-described methods implemented entirely within computer software can include, for example, computer software specifically designed to include the steps of an above-described method. Alternatively, such embodiments can include, for example, a second component of computer software (e.g., a computer-software macro) that is combined with a computer model that represents individual biological processes associated with a biological state. Such a second computer-software component can execute the computer model multiple times where, for example, a different value of Sₓ (for a biological state in the presence of an added function of set F₀) is determined; once the various values of Sₓ are determined, the macro can then compare these values Sₓ to the value S₀ (for a biological state without any added functions). The second computer-software component thereby can allow the adaptation of a preexisting computer model (i.e., a computer model that represents individual biological processes associated with a biological state) to be used according to the above-described methods.

### EXAMPLES

### Example 1

Example of a Computer Model

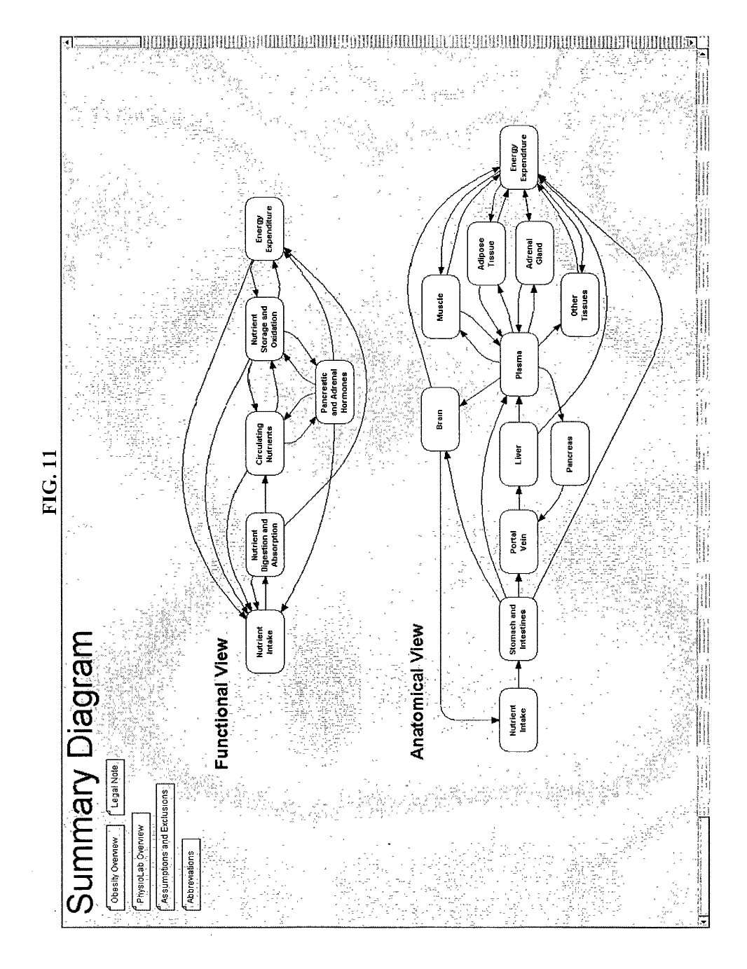

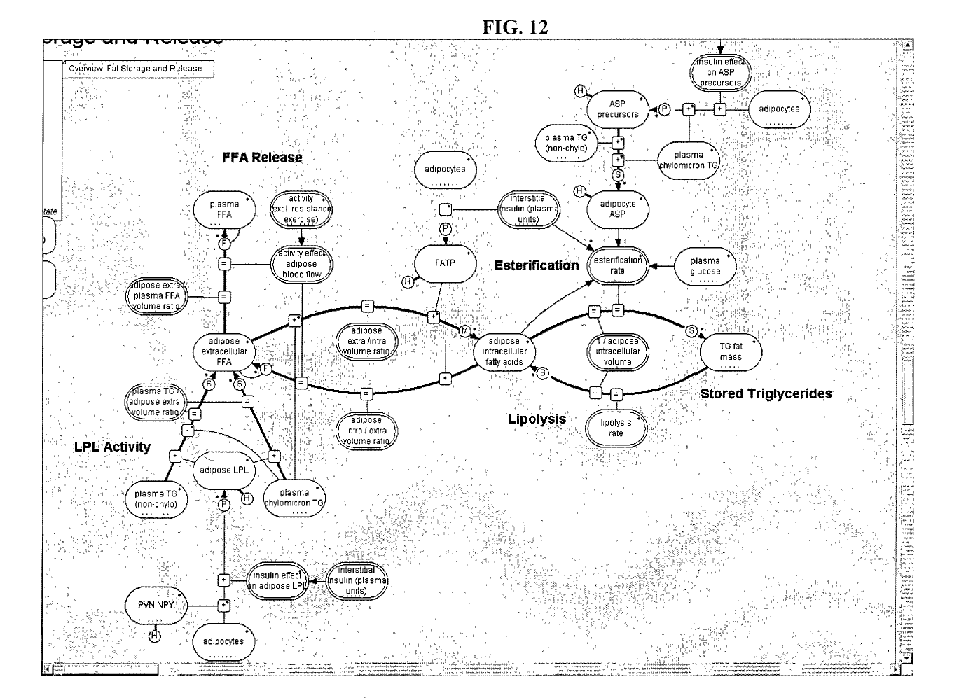

FIGS. 11 and 12 depict portions of Entelos® Obesity PhysioLab® systems. The biological state of obesity is modeled through a series of user-interface screens that define the biological processes of the biological state. These biological processes of the biological state have dynamic relationships among themselves. The model comprises of many modules. An example of a module is depicted on FIG. 12. Each module represents several biological processes. These modules when grouped together represent the biological state.

Each module models the interactions of cellular constituents and the biological processes through the use of state and function nodes whose relations are defined through the use of diagrammatic arrow symbols. The mathematical relationships for each biological process is represented in the nodes and the arrows.

State and function nodes show the names of the variables they represent and their location in the model. Their arrows and modifiers show their relation to other nodes within the model. State and function nodes also contain the parameters and equations that are used to compute the values or their variables in simulated experiments. In one embodiment of the computer model, the state and function nodes are generated according to the method described in U.S. Pat. No. 6,051,029 and co-pending application Ser. No. 09/588,855, both of which are entitled “Method of generating a display for a dynamic simulation model utilizing node and link representations,” and both of which are incorporated herein by reference. Further examples of state and function nodes are further discussed below.

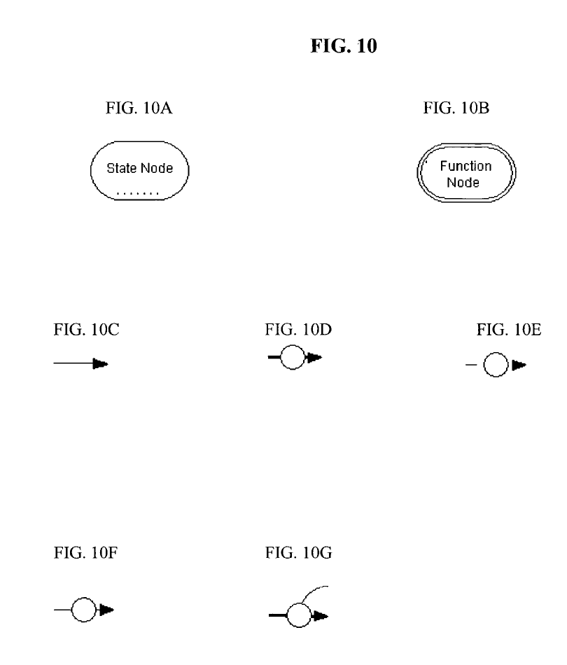

State nodes, depicted in FIG. 10A, represents variables in the system the values of which are determined by the cumulative effects of its inputs over time.

State node values are defined by differential equations. The predefined parameters for a state node include its initial value (Sₒ) and its status. State nodes that have a half-life have the additional parameter of a half-life (h) and are labeled with a half-life symbol.

Function nodes, depicted in FIG. 10B, represent variables in the system the values of which, at any point in time, are determined by inputs at that same point in time.

Function nodes are defined by algebraic functions of their inputs. The predefined parameters for a function node include its initial value (Fₒ) and its status.

Setting the status of a node effects how the value of the node is determined. The status of a state or function node can be: 1) computed—the value is calculated as a result of its inputs, 2) specified-Locked—the value is held constant over time, or 3) Specified Data—the value varies with time according to predefined data points.

All nodes are defined by their position, with respect to arrows and other nodes, as being either source nodes (S) or target nodes (T). Source nodes are located at the tails of arrows, and target nodes are located at the heads of arrows. Nodes can be active or inactive.

The computational status of a state node can be Computed, Specified-Locked, or Specified Data.

State Node Computed:

$$\frac{ⅆ S}{ⅆ t} = \{ \begin{matrix} sum of arrowterms & when h = 0 \\ \frac{ln \frac{1}{2}}{h} S ( t ) + sum of arrowterms & when h > 0\end{matrix}$$

Where S is the node value, t is time, S(t) is the node value at time, t, and h is the half-life. The three dots at the end of the equation indicate there are additional terms in the equation resulting from any effect arrows leading into it and by any conversion arrows that lead out of it. If h is equal to 0, then the half-life calculation is not performed and dS/dt is determined solely by the arrows attached to the node.

State Node Specified-Locked:

S(t)=S₀ for all t

[symbol]

State Node Specified Data S(t) is defined by specified data entered for the state node.

State node values can be limited to a minimum value of zero and a maximum value of one. If limited at zero, S can never be less than zero and the value for S is reset to zero if it goes negative. If limited at one, S cannot be greater than one and is reset to one if it exceeds one.

Function node equations are computed by evaluating the specified function of the values of the nodes with arrows pointing into the function node (arguments), plus any object and Effect Diagram parameters used in the function expression.

Arrows link source nodes to target nodes and represent the mathematical relationship between the nodes. Arrows can be labeled with circles that indicate the activity of the arrow. If an arrowhead is solid, the effect is positive. If the arrowhead is hollow, the effect is negative.

Effect arrows, depicted in FIG. 10F, link source state or function nodes to target state nodes. Effect arrows cause changes to target nodes but have no effect on source nodes. They are labeled with circles that indicate the activity of the arrow.

Conversion arrows, depicted in FIG. 10D, represent the way the contents of state nodes are converted into the contents of the attached state nodes. They are labeled with circles that indicate the activity of the arrow. The activity may effect the source node or the target node or both nodes. The conversion can go either way.

Argument arrows, depicted in FIG. 10C, specify which nodes are input arguments for function nodes. They do not contain parameters or equations and are not labeled with activity circles.

Effect or conversion arrows can be constant, proportional, or interactive. Arrows that are constant have a break in the arrow shaft, depicted in FIG. 10E. They are used when the rate of change of the target is independent of the values of the source and target nodes.

Arrows that are proportional have solid, unbroken shafts and are used when the rate of change is dependent on, or is a function of, the values of the source node.

Arrows that are interactive have a loop from the activity circle to the target node, depicted in FIG. 10G. They indicate that the rate of change of the target is dependent on, or a function of, the value of both the source node and the target node.

Proportional Effect Arrow: The rate of change of target tracks source node value.

$$\frac{ⅆ T}{ⅆ t} = C \cdot {S ( t )}^{a} + …$$

Where T is the target node, C is a coefficient, S is the source node, and a is an exponent.

Constant Effect Arrow: The rate of change of the target is constant.

$$\frac{ⅆ T}{ⅆ t} = K + …$$

Where T is the target node and K is a constant.

Interaction Effect Arrow: The rate of change of the target depends on both the source node and target node values.

$$\frac{ⅆ T}{ⅆ t} = C ( {S ( t )}^{a} - {T ( t )}^{b} ) + …$$

Where T is the target node, S is the source node, and a and b are exponents. This equation can vary depending on the operation selected in the Object window. The operations available are S+T, S−T, S*T, T/S, and S/T.

Proportional Conversion Arrow: The rate of change of the target tracks the value of source node.

$$\frac{ⅆ T}{ⅆ t} = C \cdot R \cdot {S ( t )}^{a} + …$$

$$\frac{ⅆ S}{ⅆ t} = - C \cdot {S ( t )}^{a} + …$$

Where T is the target node, S is the source node, C is a coefficient, R is a conversion ratio, and a is an exponent.

Constant Conversion Arrow: The rates of change of target and source are constant such that an increase in target corresponds to a decrease in source.

$$\frac{ⅆ T}{ⅆ t} = K \cdot R + …$$

$$\frac{ⅆ S}{ⅆ t} = - K +$$

Where T is the target node, S is the source node, K is a constant, and R is a conversion ratio.

Interaction Conversion Arrow: The rates of change of the target and source depend on both source and target node values such that an increase in target corresponds to a decrease in source.

$$\frac{ⅆ T}{ⅆ t} = R \cdot C ( {S ( t )}^{a} - {T ( t )}^{b} ) + \\ \frac{ⅆ S}{ⅆ t} = - C ( {S ( t )}^{a} - {T ( t )}^{b} ) + …$$

Where T is the target node, S is the source node, a and b are exponents, and R is a conversion ratio. This equation can vary depending on the operation selected in the Object window. The operations available are S+T S−T, S*T, T/S, and S/T.

Modifiers indicate the effects nodes have on the arrows to which they are connected. For example, a node can allow, block, regulate, inhibit, or stimulate an arrow rate.

Effect Arrow, Modifier Equation:

$$\frac{ⅆ T}{ⅆ t} = M \cdot f ( \frac{u}{N} ) \cdot arrowterm +$$

Where T is the target node, M is a multiplier constant, N is a normalization constant, ∫( ) is a function (either linear or specified by a transform curve), and arrowterm is an equation fragment from the attached arrow.

By default, conversion arrow modifiers affect both the source and target arrow terms. However, in some cases, a unilateral, modifier is used. Such modifier will affect either a source arrow term or on target arrow term; it does not affect both arrow terms.

Conversion arrow, Source Only Modifier Equation:

$$\frac{ⅆ S}{ⅆ t} = M \cdot f ( \frac{u}{N} ) \cdot arrowterm + other attached arrowterms$$

Conversion arrow, Target Only Modifier Equation:

$$\frac{ⅆ T}{ⅆ t} = M \cdot f ( \frac{u}{N} ) \cdot arrowterm + other attached arrowterms$$

The equation for a source and target modifier uses both the Source Only equation and the Target Only equation.

When multiplicative and additive modifers are combined, effect is given precedence. For example, if the following modifiers are on an arrow,

a1,a2: Additive, Source and Target

m1,m2: Multiplicative, Source and Target

A1,A2: Additive, Target Only

M1,M2: Multiplicative, Target Only

then the rates are modified by

Target node: (a1+a2+A1+A2)*(m1*m2)*(M1*M2)

Source node: (a1+a2)*(m1*m2)

The nodes, arrows, and the accompanying equations described above are some of the tools used to develop the commercially available Entelos® Asthma PhysioLab® systems, Entelos® Obesity PhysioLab® systems and Entelos® Adipocyte CytoLab™ systems.

### Example 2

Prediction of Biological Activity of 5-lipoxygenase in Asthma

An exemplary method of the invention was assessed using a known gene, 5-lipoxygenase. The functions of this gene are known in the art. This method was performed using the commercially available model of asthma, Entelos® Asthma PhysioLab® systems.

Using the Entelos® Asthma PhysioLab® systems, a modeled asthmatic patient was exposed to an allergen. FIGS. 4 and 5 are screen shots from the Entelos® Asthma PhysioLab® systems. FIG. 4 depicts the various parameters and their values that can be modified to obtain the responses of a modeled asthma patient to an allergen. FIG. 5 depicts the allergen challenge set-up for the modeled asthma patient.

In asthmatics, following exposure to an allergen, lung function is compromised by partial closure of airways due to smooth muscle contraction, tissue swelling, and mucus production. In response to an allergen stimulus, a typical biphasic response is observed in an asthmatic patient. A similar biphasic response depicted in FIG. 6A is observed in the modeled asthmatic patient exposed to an allergen. The, response in FIG. 6A was obtained using the experimental set-up depicted on FIG. 5. FIG. 6A depicts airway conductance as forced expiratory volume in one second (FEV₁). In the modeled patient, concurrent with the biphasic response an increase in three lipid mediators, prostaglandins, platelet activating factor (PAF), and cysteinyl leukotrienes (CysLT), is observed. This increase in inflammatory mediators is depicted on FIGS. 6B and 6C.

Based on the increase in inflammatory mediators observed in the Entelos Asthma PhysioLab® systems, three functions were assigned to 5-lipoxygenase. These functions were the production of one of three different lipid mediators, i.e. prostaglandins, PAF, and CysLT, during an asthma attack.

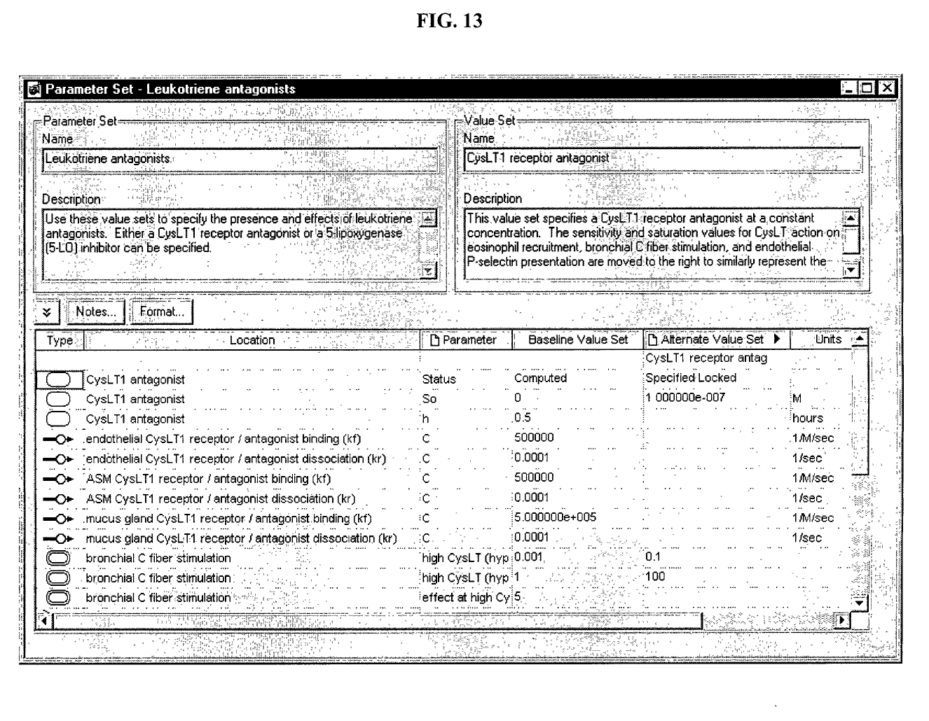

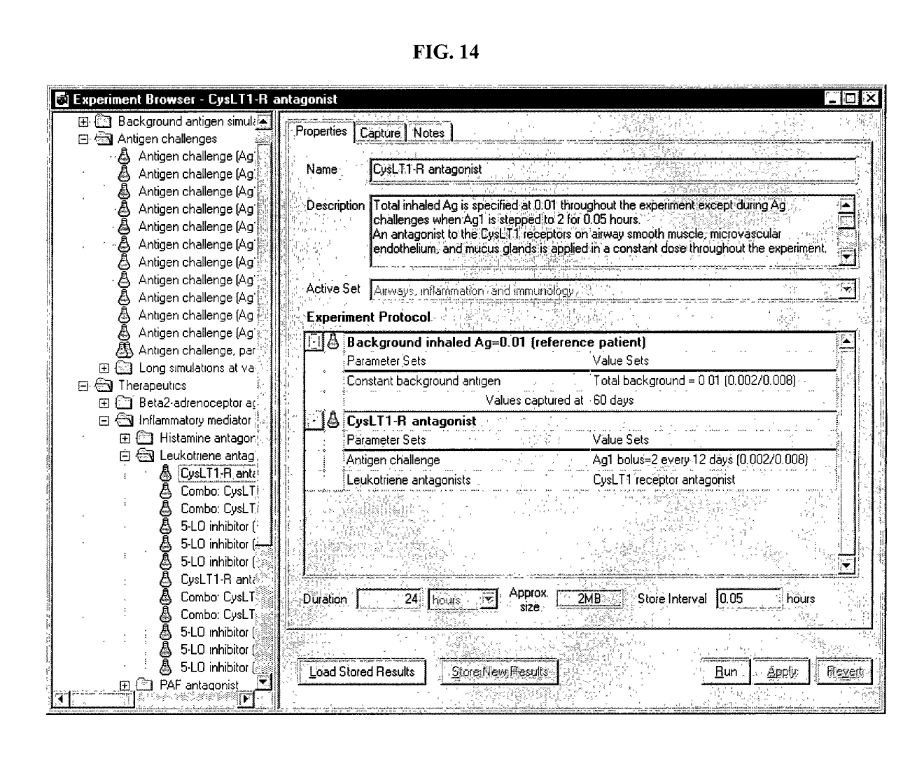

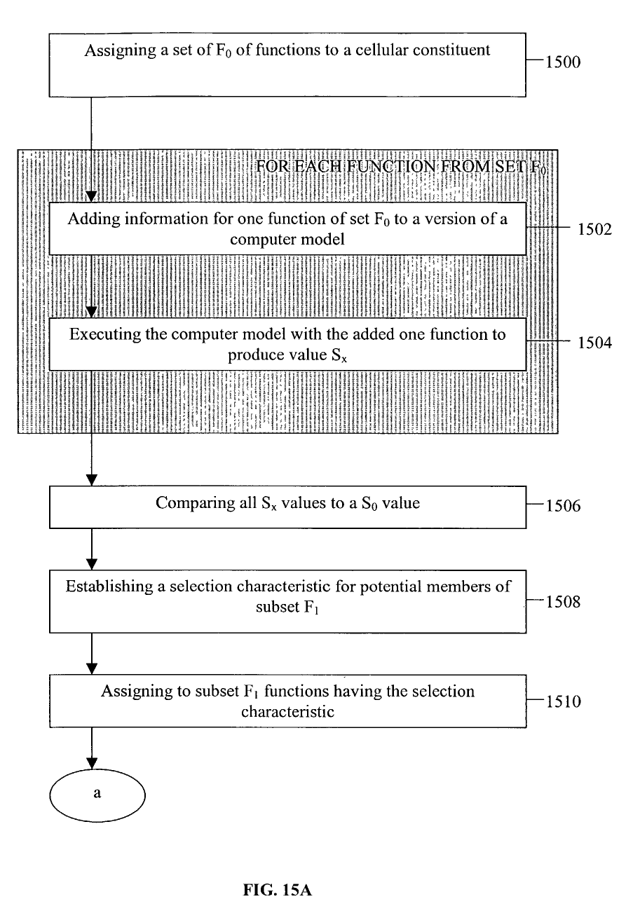

Next, the information for each of the function was input into the computer model. The information was input by modifying the activity of each of the inflammatory mediator. The activity of each inflammatory mediator was blocked using an antagonist., FIGS. 13 and 14 depict how the effect of a CysLT antagonist is incorporated into the model of the asthmatic patient. On FIG. 13 is shown the various parameters and their values, that can be modified to evaluate the effects of blocking CysLT with an antagonist. FIG. 14 depicts the experimental set-up of exposing an asthmatic patient to an allergen in the presence of a CysLT antagonist. Similar blocking with antagonists was performed for prostaglandins and PAF. The results of the blocking are shown in FIGS. 7A, 7B, and 7C. FIG. 7D depicts airway conductance in the absence of blocking of any of the inflammatory mediators. Blocking of prostaglandins and PAF showed a small improvement in FEV₁ compared to when these two biological processes were not modified. But, this small improvement would not have resulted in an improvement in airway conductance in an asthmatic patient. But blocking of cysteinyl leukotrienes brought back the airway conductance to normal (see FIGS. 7A, 7B, 7C and 7D).

If parameters for a receptor antagonist are not present in the model, the inflammatory mediator of interest can be blocked by modifying the nodes and/or links associated with the inflammatory mediator.

This experiment shows that CysLT plays a potential role in the changes in airway conductance observed in an asthmatic patient in response to an allergen. Also, this experiment suggests that if 5-lipoxygenase modulates the production of CysLT then it may be a valuable target for the development of asthma therapy. The next step would be to confirm this putative function of 5-lipoxygenase with in vitro and/or in vivo experiments. If none of the putative functions had resulted in a clinically significant result, the gene might be abandoned as a potential target or additional functions may be hypothesized and the process repeated.

All publications and patent applications mentioned in this specification are herein incorporated by reference to the same extent as if each individual publication or patent application was specifically and individually indicated to be incorporated by reference.

The invention now being fully described, it will be apparent to one of ordinary skill in the art that many changes and modifications can be made thereto without departing from the spirit or scope of the appended claims.

What is claimed is:

1. A method for predicting potential biological activity of a cellular constituent for affecting a biological state S comprising:
(a) assigning a set F₀ of functions to said cellular constituent, each function of set F₀ being a modification of at least one biological process of said biological state S;
(b) adding information for one function of set F₀ to a computer model of said biological state, said computer model representing a plurality of individual biological processes associated with said biological state, at least one of said plurality of individual biological processes being a process modified by said one function of set F₀, said computer model being configured to evaluate the effect of said biological processes on said biological state;
(c) executing said computer model with said added one function of set F₀ to produce value Sₓ for said biological state in the presence of said added one function of set F₀;
(d) repeating steps (b) and (c) for any other functions of set F₀;
(e) comparing all of said Sₓ values for functions of set F₀ to an S₀ value, said S₀ value being produced by executing said computer model without any of the functions of set F₀ being added into said computer model; and
(f) identifying the functions in set F₀ having a difference in Sₓ value relative to S₀ as having a higher potential biological activity of said cellular constituent for affecting said biological state and identifying the functions in set F₀ having substantially no difference in Sₓ value relative to S₀ as having a lesser potential biological activity for affecting said biological state.

2. The method of claim 1, further comprising:
obtaining experimental information on biological activity of said cellular constituent for at least one individual biological process in said computer model;
adding said experimental information to said computer model;
re-evaluating S_{X} values for each of said functions of set F₀; and
using said re-evaluated S_{X} values to re-order, if necessary, priority of scientific investigation on functions of cellular constituents for ability to affect said biological state.

3. The method of claim 1, wherein functions of set F₀ are ordered in a subset F₁ from greatest difference in Sₓ values relative to S₀ to lowest difference in Sₓ values relative to S₀, and priority of a scientific investigation is ordered based on said ordered set.

4. The method according to claim 1, wherein said assigning a set F₀ of functions includes obtaining experimental information on biological activity of said cellular constituent and associating said experimental information with said cellular constituent.

5. The method according to claim 1, wherein said adding information for said one function of set F₀ includes assigning a fractional contribution of said one cellular constituent to at least one of said plurality of individual biological processes.

6. The method according to claim 1, wherein said cellular constituent is selected from the group consisting of polynucleotides and polypeptides.

7. A method for selecting a subset Z₁ of cellular constituents having a potential biological activity for affecting biological state S from a set Z₀ of cellular constituents, comprising:
(a) assigning a set F₀ of functions to each cellular constituent of set Z₀, each function being a modification of at least one biological process of said biological state S;
(b) adding information for one of said functions of set F₀ for one of said cellular constituents of set Z₀ to a computer model of said biological state, said computer model representing a plurality of individual biological processes associated with said biological state, at least one of said plurality of individual biological processes being a process modified by said one function of set F₀, said computer model being configured to evaluate the effect of said individual biological processes on said biological state;
(c) executing said computer model with said added one function of set F₀ of said one cellular constituent being incorporated into the computer model to produce a value S_{X} for said biological state in the presence of said one function of set F₀ of said one cellular constituent;
(d) repeating steps (b) and (c) for any other functions of set F₀;
(e) repeating steps (b), (c) and (d) for any other cellular constituents of set Z₀;
(f) comparing all of said S_{X} values for cellular constituents in set Z₀ to a S₀ value, said S₀ value being produced by executing said computer model without any of said functions of any of said cellular constituents being added into the computer model;
(g) establishing a selection characteristic for potential members of said subset Z₁, said selection characteristic being a range of differences between Sₓ values for cellular constituents in set Z₀ to S₀; and
(h) assigning to said subset Z₁ cellular constituents having said selection characteristic, the difference in Sₓ values to S₀ value being correlated to the potential biological activity of said cellular constituent for affecting said biological state.

8. The method of claim 7, further comprising:
creating a subset Z₂ of cellular constituents from said subset Z₁ of cellular constituents, said creating the subset Z₂ of cellular constituents, comprising:
(a) perturbing one of the cellular constituents of subset Z₁ in a biological assay system;
(b) executing said biological assay system in the presence of said perturbed cellular constituent to produce a set of function values, each function value FVₓ of said set of function values being related to at least one function of set F₀ of said perturbed cellular constituent;
(c) repeating steps (a) and (b) for any other cellular constituents of subset Z₁;
(d) comparing each function value FVₓ to a function value FV₀, the function value FV₀ being produced without perturbation of said cellular constituents in said biological assay system;
(e) establishing a selection characteristic for potential members of subset Z_{2,} said selection characteristic being a range of differences between FVₓ and FV₀ values; and
(f) assigning to said subset Z₂ cellular constituents having said selection characteristic, the selection characteristic for potential members of subset Z₂ being correlated to the effect of the perturbation of said cellular constituent on the functions of set F₀.

9. The method of claim 7, further comprising:
obtaining experimental information on biological activity of each cellular constituent in subset Z₁ for at least one individual biological process in said computer model;
adding said experimental information to said computer model;
re-evaluating Sₓ values for each of said cellular constituents in subset Z₁; and
using said re-evaluated S_{X} values to re-order, if necessary, priority of a scientific investigation on cellular constituents in subset Z₁ for ability to affect said biological state.

10. The method of claim 7, wherein set Z₁ is an ordered set in which set members are ordered from greatest difference in Sₓ values relative to S₀ to lowest difference in Sₓ values relative to S₀, and priority of a scientific investigation is ordered based on said ordered set.

11. The method according to claim 7, wherein said assigning a set F₀ of functions includes obtaining experimental information on biological activity of said cellular constituent and associating said experimental information with said cellular constituent.

12. The method according to claim 7, wherein said adding information for said one function of set F₀ includes assigning a fractional contribution of said one cellular constituent to at least one of said plurality of individual biological processes.

13. The method according to claim 7, wherein said cellular constituents are selected from the group consisting of polynucleotides and polypeptides.

14. A method for identifying potential biological processes of a biological state modulated by a cellular constituent comprising:
(a) assigning a function to said cellular constituent, said function being a modification of at least one biological process of said biological state;
(b) adding information for said function to a computer model of said biological state, said computer model representing a plurality of individual biological processes associated with said biological state, at least one of said plurality of individual biological processes being a process modified by said function, said computer model being configured to evaluate the effect of said biological processes on said biological state;
(c) executing said computer model so that a virtual stimulus in the presence of said function is presented to produce a response value Rₓ for said biological state in the presence of said function;
(d) providing a biological stimulus to a biological assay system to produce a biological response value BRₓ for said biological assay system in the presence of said biological stimulus, said biological stimulus being the biological equivalent of the virtual stimulus and said biological assay system being the biological equivalent of the said biological state;
(f) establishing a selection characteristic for identifying potential biological processes of said biological state modulated by said cellular constituent, wherein said selection characteristic being a range of differences between the response value Rₓ and the biological response value BRₓ; and
(g) identifying said biological process having said selection characteristic as a potential biological process of said biological state modulated by said cellular constituent.

15. The method according to claim 14, wherein said assigning a function includes obtaining experimental information on biological activity of said cellular constituent and associating said experimental information with said cellular constituent.

16. The method according to claim 14, wherein said adding information for said function includes assigning a fractional contribution of said one cellular constituent to at least one of said plurality of individual biological processes.

17. The method according to claim 14, wherein said cellular constituent is selected from the group consisting of polynucleotides and polypeptides.

18. The method according to claim 14, wherein said biological assay system is selected from the group consisting of a cell-based system and an animal model.

19. A method for predicting potential biological activity of a cellular constituent for affecting a biological state S, comprising:
(a) assigning a set F₀ of functions to said cellular constituent, each function of set F₀ being a modification of at least one biological process of said biological state S;
(b) adding information for one function of set F₀ to a computer model of said biological state, said computer model representing a plurality of individual biological processes associated with said biological state, at least one of said plurality of individual biological processes being a process modified by said one function of set F₀, said computer model being configured to evaluate the effect of said biological processes on said biological state;
(c) executing said computer model with said added one function of set F₀ to produce value Sₓ for said biological state in the presence of said added one function of set F₀;
(d) repeating steps (b) and (c) for any other functions of set F₀;
(e) comparing all of said Sₓ values for functions of set F₀ to an S₀ value, said S₀ value being produced by executing said computer model without any of the functions of set F₀ being incorporated into said computer model;
(f) establishing a selection characteristic for potential members of a subset F₁ of set F₀, said selection characteristic being a range of differences between Sₓ values for functions in set F₀ to S₀; and
(g) assigning to said subset F₁ functions having said selection characteristic, the selection characteristic for potential members of subset F₁ being correlated to the potential biological activity of said cellular constituent for affecting said biological state.

20. The method of claim 19, further comprising:
creating a subset F₂ of functions of said cellular constituent from said subset F₁ of functions, said creating the subset F₂ of functions, comprising:
(a) perturbing said cellular constituent in a biological assay system;
(b) executing said biological assay system in the presence of said perturbed cellular constituent to produce a set of function values, each function value FVₓ of said set of function values being related to one function of subset F₁;
(c) comparing each function value FVₓ to a function value FV₀, the function value FV₀ being a value produced without perturbation of said cellular constituent in said biological assay system;
(d) establishing a selection characteristic for potential members of said subset F₂, said selection characteristic being a range of differences between FVₓ values and FV₀ values; and
(e) assigning to said subset F₂ functions having said selection characteristic, the selection characteristic for potential members of subset F₂ being correlated to the effect of the perturbation of said cellular constituent on the functions of subset F₁.

21. A method for predicting potential biological activity of a cellular constituent for affecting a biological state S, the method using a computer model that represents a plurality of individual biological processes associated with said biological state, said computer model being configured to evaluate an effect of said individual biological processes on said biological state, the method comprising:
(a) assigning a set F₀ of functions to said cellular constituent, each function of set F₀ being a modification of at least one biological process of said biological state S;
(b) performing the following for each function from the set F₀:
(i) adding information for one function of set F₀ to a version of the computer model without added information for the remaining functions of set F₀, at least one of said plurality of individual biological processes being a process modified by said added one function of set F₀; and
(ii) executing said computer model with said added one function of set F₀ to produce value Sₓ for said biological state in the presence of said added one function of set F₀;
(c) comparing all of said Sₓ values for functions of set F₀ to an S₀ value, said S₀ value being produced by executing said computer model without any of the functions of set F₀ being incorporated into said computer model; and
(d) identifying the functions in set F₀ having a difference in its associated Sₓ value relative to S₀ as having a higher potential biological activity of said cellular constituent for affecting said biological state and identifying the functions in set F₀ having substantially no difference in Sₓ value relative to S₀ as having a lesser potential biological activity for affecting said biological state.
